(19) United States
(12) Patent Application Publication
(10) Pub. No.: US 2006/0233699 A1
(43) Pub. Date: Oct. 19, 2006

(54) Plasma reactor and process for producing lower-energy hydrogen species

(76) Inventor: Randell L. Mills, Princeton, NJ (US)

Correspondence Address: MANELLI DENISON & SELTER, 2000 M STREET NW SUITE 700, WASHINGTON, DC, 20036-3307, US

(21) Appl. No.: 10/552,585

(22) PCT Filed: Apr. 8, 2004
(86) PCT No.: PCT/US04/10608

§ 371 Date: Oct. 12, 2005

Related U.S. Application Data
(60) Provisional application No. 60/462,705, filed on Apr. 15, 2003.

(51) Int. Cl. C01B 3/02

(52) U.S. Cl. 423/648.1

(57) ABSTRACT

This invention relates to a reactor to generate power, plasma, light, and novel hydrogen compounds by the catalysis of atomic hydrogen. The power balance is optimized by maximizing the output power from the hydrogen catalysis reaction while minimizing the input power by controlling the parameters of the input power to initiate or at least partially maintain the plasma such as the power density, pulse frequency, duty cycle, and peak and offset electric fields.

This application claims priority to U.S. Application Ser. No. 60/462,705, filed Apr. 15, 2004, the complete disclosure of which is incorporated herein by reference.

### I. INTRODUCTION

1. Field of the Invention

This invention relates to a reactor to generate power, plasma, light, and novel hydrogen compounds by the catalysis of atomic hydrogen. The power balance is optimized by maximizing the output power from the hydrogen catalysis reaction while minimizing the input power by controlling the parameters of the input power to initiate or at least partially maintain the plasma such as the power density, pulse frequency, duty cycle, and peak and offset electric fields.

2. Background of the Invention

2.1 Hydrinos

A hydrogen atom having a binding energy given by

$$Binding Energy = \frac{13.6 eV}{{( \frac{1}{p} )}^{2}} \qquad ( 1 )$$

where p is an integer greater than 1, preferably from 2 to 137, is disclosed in R. Mills, The Grand Unified Theory of Classical Quantum Mechanics, January 2000 Edition, BlackLight Power, Inc., Cranbury, N.J., (“'00 Mills GUT”), provided by BlackLight Power, Inc., 493 Old Trenton Road, Cranbury, N.J., 08512; R. Mills, The Grand Unified Theory of Classical Quantum Mechanics, September 2001 Edition, BlackLight Power, Inc., Cranbury, N.J., Distributed by Amazon.com (“'01 Mills GUT”), provided by BlackLight Power, Inc., 493 Old Trenton Road, Cranbury, N.J., 08512; R. Mills, The Grand Unified Theory of Classical Quantum Mechanics, January 2004 Edition, BlackLight Power, Inc., Cranbury, N.J., (“'04 Mills GUT”), provided by BlackLight Power, Inc., 493 Old Trenton Road, Cranbury, N.J., 08512 (posted at www.blacklightpower.com); R. L. Mills, Y. Lu, M. Nansteel, J. He, A. Voigt, B. Dhandapani, “Energetic Catalyst-Hydrogen Plasma Reaction as a Potential New Energy Source”, Division of Fuel Chemistry, Session: Chemistry of Solid, Liquid, and Gaseous Fuels, 227th American Chemical Society National Meeting, Mar. 28-Apr. 1, 2004, Anaheim, Calif.; R. Mills, B. Dhandapani, J. He, “Highly Stable Amorphous Silicon Hydride from a Helium Plasma Reaction”, Materials Science and Engineering: B, submitted; R. L. Mills, Y. Lu, B. Dhandapani, “Spectral Identification of H₂ (½)”, submitted; R. L. Mills, Y. Lu, J. He, M. Nansteel, P. Ray, X. Chen, A. Voigt, B. Dhandapani, “Spectral Identification of New States of Hydrogen”, Applied Spectroscopy, submitted; R. Mills, P. Ray, B. Dhandapani, “Evidence of an Energy Transfer Reaction Between Atomic Hydrogen and Argon II or Helium II as the Source of Excessively Hot H Atoms in RF Plasmas”, Contributions to Plasma Physics, submitted; J. Phillips, C. K. Chen, R. Mills, “Evidence of the Production of Hot Hydrogen Atoms in RF Plasmas by Catalytic Reactions Between Hydrogen and Oxygen Species”, Spectrochimica Acta Part B: Atomic Spectroscopy, submitted; R. L. Mills, P. Ray, B. Dhandapani, “Excessive Balmer α Line Broadening of Water-Vapor Capacitively-Coupled RF Discharge Plasmas” IEEE Transactions on Plasma Science, submitted; R. L. Mills, “The Nature of the Chemical Bond Revisited and an Alternative Maxwellian Approach”, Physics Essays, submitted; R. L. Mills, P. Ray, M. Nansteel, J. He, X. Chen, A. Voigt, B. Dhandapani, “Energetic Catalyst-Hydrogen Plasma Reaction Forms a New State of Hydrogen”, Doklady Chemistry, submitted; R. L. Mills, P. Ray, M. Nansteel, J. He, X. Chen, A. Voigt, B. Dhandapani, Luca Gamberale, “Energetic Catalyst-Hydrogen Plasma Reaction as a Potential New Energy Source”, Central European Journal of Physics, submitted; R. Mills, P. Ray, “New H I Laser Medium Based on Novel Energetic Plasma of Atomic Hydrogen and Certain Group I Catalysts”, J. Plasma Physics, submitted; R. L. Mills, P. Ray, M. Nansteel, J. He, X. Chen, A. Voigt, B. Dhandapani, “Characterization of an Energetic Catalyst-Hydrogen Plasma Reaction as a Potential New Energy Source”, Am. Chem. Soc. Div. Fuel Chem. Prepr., Vol. 48, No. 2, (2003); R. Mills, P. C. Ray, M. Nansteel, W. Good, P. Jansson, B. Dhandapani, J. He, “Hydrogen Plasmas Generated Using Certain Group I Catalysts Show Stationary Inverted Lyman Populations and Free-Free and Bound-Free Emission of Lower-Energy State Hydride”, Fizika A, submitted; R Mills, J. Sankar, A. Voigt, J. He, P. Ray, B. Dhandapani, “Role of Atomic Hydrogen Density and Energy in Low Power CVD Synthesis of Diamond Films”, Thin Solid Films, submitted; R. Mills, B. Dhandapani, M. Nansteel, J. He, P. Ray, “Liquid-Nitrogen-Condensable Molecular Hydrogen Gas Isolated from a Catalytic Plasma Reaction”, J. Phys. Chem. B, submitted; R. L. Mills, P. Ray, J. He, B. Dhandapani, M. Nansteel, “Novel Spectral Series from Helium-Hydrogen Evenson Microwave Cavity Plasmas that Matched Fractional-Principal-Quantum-Energy-Level Atomic and Molecular Hydrogen”, European Journal of Physics, submitted; R. L. Mills, P. Ray, R. M. Mayo, Highly Pumped Inverted Balmer and Lyman Populations, New Journal of Physics, submitted; R. L. Mills, P. Ray, J. Dong, M. Nansteel, R. M. Mayo, B. Dhandapani, X. Chen, “Comparison of Balmer α Line Broadening and Power Balances of Helium-Hydrogen Plasma Sources”, Braz. J. Phys., submitted; R. Mills, P. Ray, M. Nansteel, R. M. Mayo, “Comparison of Water-Plasma Sources of Stationary Inverted Balmer and Lyman Populations for a CW HI Laser”, J. Appl. Spectroscopy, in preparation; R. Mills, J. Sankar, A. Voigt, J. He, P. Ray, B. Dhandapani, “Synthesis and, Characterization of Diamond Films from MPCVD of an Energetic Argon-Hydrogen Plasma and Methane”, J. of Materials Research, submitted; R. Mills, P. Ray, B. Dhandapani, W. Good, P. Jansson, M. Nansteel, J. He, A. Voigt, “Spectroscopic and NMR Identification of Novel Hydride Ions in Fractional Quantum Energy States Formed by an Exothermic Reaction of Atomic Hydrogen with Certain Catalysts”, European Physical Journal-Applied Physics, in press; R. L. Mills, The Fallacy of Feynman's Argument on the Stability of the Hydrogen Atom According to Quantum Mechanics, Fondation Louis de Broglie, submitted; R. Mills, J. He, B. Dhandapani, P. Ray, “Comparison of Catalysts and Microwave Plasma Sources of Vibrational Spectral Emission of Fractional-Rydberg-State Hydrogen Molecular Ion”, Canadian Journal of Physics, submitted; R. L. Mills, P. Ray, X. Chen, B. Dhandapani, “Vibrational Spectral Emission of Fractional-Principal-Quantum-Energy-Level Molecular Hydrogen”, J. of the Physical Society of Japan, submitted; J. Phillips, R. L. Mills, X. Chen, “Water Bath Calorimetric Study of Excess Heat in ‘Resonance Transfer’ Plasmas”, Journal of Applied Physics, in press; R. L. Mills, P. Ray, B. Dhandapani, X. Chen, “Comparison of Catalysts and Microwave Plasma Sources of Spectral Emission of Fractional-Principal-Quantum-Energy-Level Atomic and Molecular Hydrogen”, Journal of Applied Spectroscopy, submitted; R. L. Mills, B. Dhandapani, M. Nansteel, J. He, P. Ray, “Novel Liquid-Nitrogen-Condensable Molecular Hydrogen Gas”, Acta Physica Polonica A, submitted; R. L. Mills, P. C. Ray, R. M. Mayo, M. Nansteel, B. Dhandapani, J. Phillips, “Spectroscopic Study of Unique Line Broadening and Inversion in Low Pressure Microwave Generated Water Plasmas”, J. Plasma Physics, submitted; R. L. Mills, P. Ray, B. Dhandapani, J. He, “Energetic Helium-Hydrogen Plasma Reaction”, AIAA Journal, submitted; R. L. Mills, M. Nansteel, P. C. Ray, “Bright Hydrogen-Light and Power Source due to a Resonant Energy Transfer with Strontium and Argon Ions”, Vacuum, submitted; R. L. Mills, P. Ray, B. Dhandapani, J. Dong, X. Chen, “Power Source Based on Helium-Plasma Catalysis of Atomic Hydrogen to Fractional Rydberg States”, Contributions to Plasma Physics, submitted; R. Mills, J. He, A. Echezuria, B Dhandapani, P. Ray, “Comparison of Catalysts and Plasma Sources of Vibrational Spectral Emission of Fractional-Rydberg-State Hydrogen Molecular Ion”, European Journal of Physics D, submitted; R. L. Mills, J. Sankar, A. Voigt, J. He, B. Dhandapani, “Spectroscopic Characterization of the Atomic Hydrogen Energies and Densities and Carbon Species During Helium-Hydrogen-Methane Plasma CVD Synthesis of Diamond Films”, Chemistry of Materials, Vol. 15, (2003), pp. 1313-1321; R. Mills, P. Ray, R. M. Mayo, “Stationary Inverted Balmer and Lyman Populations for a CW HI Water-Plasma Laser”, IEEE Transactions on Plasma Science, submitted; R, L. Mills, P. Ray, “Extreme Ultraviolet Spectroscopy of Helium-Hydrogen Plasma”, J. Phys. D, Applied Physics, Vol. 36, (2003), pp. 1535-1542; R. L. Mills, P. Ray, “Spectroscopic Evidence for a Water-Plasma Laser”, Europhysics Letters, submitted; R. Mills, P. Ray, “Spectroscopic Evidence for Highly Pumped Balmer and Lyman Populations in a Water-Plasma”, J. of Applied Physics, submitted; R. L. Mills, J. Sankar, A. Voigt, J. He, B. Dhandapani, “Low Power MPCVD of Diamond Films on Silicon Substrates”, Journal of Vacuum Science & Technology A, submitted; R. L. Mills, X. Chen, P. Ray, J. He, B. Dhandapani, “Plasma Power Source Based on a Catalytic Reaction of Atomic Hydrogen Measured by Water Bath Calorimetry”, Thermochimica Acta, Vol. 406/1-2, pp. 35-53; R. L. Mills, A. Voigt, B. Dhandapani, J. He, “Synthesis and Spectroscopic Identification of Lithium Chloro Hydride”, Materials Characterization, submitted; R. L. Mills, B. Dhandapani, J. He, “Highly Stable Amorphous Silicon Hydride”, Solar Energy Materials & Solar Cells, Vol. 80, No. 1, pp. 1-20; R. L. Mills, J. Sankar, P. Ray, A. Voigt, J. He, B. Dhandapani, “Synthesis of HDLC Films from Solid Carbon”, Journal of Materials Science, in press; R. Mills, P. Ray, R. M. Mayo, “The Potential for a Hydrogen Water-Plasma Laser”, Applied Physics Letters, Vol. 82, No. 11, (2003), pp. 1679-1681; R. L. Mills, “Classical Quantum Mechanics”, Physics Essays, in press; R. L. Mills, P. Ray, “Spectroscopic Characterization of Stationary Inverted Lyman Populations and Free-Free and Bound-Free Emission of Lower-Energy State Hydride Ion Formed by a Catalytic Reaction of Atomic Hydrogen and Certain Group I Catalysts”, Journal of Quantitative Spectroscopy and Radiative Transfer, No. 39, sciencedirect.com, Apr. 17, 2003; R. M. Mayo, R. Mills, “Direct Plasmadynamic Conversion of Plasma Thermal Power to Electricity for Microdistributed Power Applications”, 40th Annual Power Sources Conference, Cherry Hill, N.J., Jun. 10-13, 2002, pp. 14; R. Mills, P. Ray, R M. Mayo, “Chemically-Generated Stationary Inverted Lyman Population for a CW HI Laser”, European J of Phys. D, submitted; R. L. Mills, P. Ray, “Stationary Inverted Lyman Population Formed from Incandescently Heated Hydrogen Gas with Certain Catalysts”, J. Phys. D, Applied Physics, Vol. 36, (2003), pp. 1504-1509; R. Mills, “A Maxwellian Approach to Quantum Mechanics Explains the Nature of Free Electrons in Superfluid Helium”, Low Temperature Physics, submitted; R. Mills and M. Nansteel, P. Ray, “Bright Hydrogen-Light Source due to a Resonant Energy Transfer with Strontium and Argon Ions”, New Journal of Physics, Vol. 4, (2002), pp. 70.1-70.28; R. Mills, P. Ray, R. M. Mayo, “CW HI Laser Based on a Stationary Inverted Lyman Population Formed from Incandescently Heated Hydrogen Gas with Certain Group I Catalysts”, IEEE Transactions on Plasma Science, Vol. 31, No. 2, (2003), pp. 236-247; R. L. Mills, P. Ray, J. Dong, M. Nansteel, B. Dhandapani, J. He, “Spectral Emission of Fractional-Principal-Quantum-Energy-Level Atomic and Molecular Hydrogen”; Vibrational Spectroscopy, Vol. 31, No. 2, (2003), pp. 195-213; R. L. Mills, P. Ray, B. Dhandapani, J. He, “Comparison of Excessive Balmer a Line Broadening of Inductively and Capacitively Coupled RF, Microwave, and Glow Discharge Hydrogen Plasmas with Certain Catalysts”, IEEE Transactions on Plasma Science, Vol. 31, No. (2003), pp. 338-355; R. M. Mayo, R. Mills, M. Nansteel, “Direct Plasmadynamic Conversion of Plasma Thermal Power to Electricity”, IEEE Transactions on Plasma Science, October, (2002), Vol. 30, No. 5, pp. 2066-2073; H. Conrads, R. Mills, Th. Wrubel, “Emission in the Deep Vacuum Ultraviolet from a Plasma Formed by Incandescently Heating Hydrogen Gas with Trace Amounts of Potassium Carbonate”, Plasma Sources Science and Technology, Vol. 12, (2003), pp. 389-395; R. L. Mills, P. Ray, “Stationary Inverted Lyman Population and a Very Stable Novel Hydride Formed by a Catalytic Reaction of Atomic Hydrogen and Certain Catalysts”, Optical Materials, in press; R. L. Mills, J. He, P. Ray, B. Dhandapani, X. Chen, “Synthesis and Characterization of a Highly Stable Amorphous Silicon Hydride as the Product of a Catalytic Helium-Hydrogen Plasma Reaction”, Int. J. Hydrogen Energy, Vol. 28, No. 12, (2003), pp. 1401-1424; R. L. Mills, A. Voigt, B. Dhandapani, J. He, “Synthesis and Characterization of Lithium Chloro Hydride”, Int. J. Hydrogen Energy, submitted; R. L. Mills, P. Ray, “Substantial Changes in the Characteristics of a Microwave Plasma Due to Combining Argon and Hydrogen”, New Journal of Physics, www.njp.org, Vol. 4, (2002), pp. 22.1-22.17; R. L. Mills, P. Ray, “A Comprehensive Study of Spectra of the Bound-Free Hyperfine Levels of Novel Hydride Ion H⁻ (½), Hydrogen, Nitrogen, and Air”, Int. J. Hydrogen Energy, Vol. 28, No. 8, (2003), pp. 825-871; R. L. Mills, E. Dayalan, “Novel Alkali and Alkaline Earth Hydrides for High Voltage and High Energy Density Batteries”, Proceedings of the 17^{th} Annual Battery Conference on Applications and Advances, California State University, Long Beach, Calif., (Jan. 15-18, 2002), pp. 1-6; R M. Mayo, R. Mills, M. Nansteel, “On the Potential of Direct and MHD Conversion of Power from a Novel Plasma Source to Electricity for Microdistributed Power Applications”, IEEE Transactions on Plasma Science, August, (2002), Vol. 30, No. 4, pp. 1568-1578; R. Mills, P. C. Ray, R. M. Mayo, M. Nansteel, W. Good, P. Jansson, B. Dhandapani, J. He, “Stationary Inverted Lyman Populations and Free-Free and Bound-Free Emission of Lower-Energy State Hydride Ion Formed by an Exothermic Catalytic Reaction of Atomic Hydrogen and Certain Group I Catalysts”, J. Phys. Chem. A, submitted; R. Mills, E. Dayalan, P. Ray, B. Dhandapani, J. He, “Highly Stable Novel Inorganic Hydrides from Aqueous Electrolysis and Plasma Electrolysis”, Electrochimica Acta, Vol. 47, No. 24, (2002), pp. 3909-3926; R. L. Mills, P. Ray, B. Dhandapani, R. M. Mayo, J. He, “Comparison of Excessive Balmer a Line Broadening of Glow Discharge and Microwave Hydrogen Plasmas with Certain Catalysts”, J. of Applied Physics, Vol. 92, No. 12, (2002), pp. 7008-7022; R. L. Mills, P. Ray, 13. Dhandapani, J. He, “Emission Spectroscopic Identification of Fractional Rydberg States of Atomic Hydrogen Formed by a Catalytic Helium-Hydrogen Plasma Reaction”, Vacuum, submitted; R. L. Mills, P. Ray, B. Dhandapani, M. Nansteel, X. Chen, J. He, “New Power Source from Fractional Rydberg States of Atomic Hydrogen”, Current Applied Physics, submitted; R. L. Mills, P. Ray, B. Dhandapani, M. Nansteel, X. Chen, J. He, “Spectroscopic Identification of Transitions of Fractional Rydberg States of Atomic Hydrogen”, J. of Quantitative Spectroscopy and Radiative Transfer, in press; R. L. Mills, P. Ray, B. Dhandapani, M. Nansteel, X. Chen, J. He, “New Power Source from Fractional Quantum Energy Levels of Atomic Hydrogen that Surpasses Internal Combustion”, J. Mol. Struct., Vol. 643, No. 1-3, (2002), pp. 43-54; R. L. Mills, P. Ray, “Spectroscopic Identification of a Novel Catalytic Reaction of Rubidium Ion with Atomic Hydrogen and the Hydride Ion Product”, Int. J. Hydrogen Energy, Vol. 27, No. 9, (2002), pp. 927-935; R. Mills, J. Dong, W. Good, P. Ray, J. He, B. Dhandapani, “Measurement of Energy Balances of Noble Gas-Hydrogen Discharge Plasmas Using Calvet Calorimetry”, Int. J. Hydrogen Energy, Vol. 27, No. 9, (2002), pp. 967-978; R. L. Mills, A. Voigt, P. Ray, M. Nansteel, B. Dhandapani, “Measurement of Hydrogen Balmer Line Broadening and Thermal Power Balances of Noble Gas-Hydrogen Discharge Plasmas”, Int. J. Hydrogen Energy, Vol. 27, No. 6, (2002), pp. 671-685; R. Mills, P. Ray, “Vibrational Spectral Emission of Fractional-Principal-Quantum-Energy-Level Hydrogen Molecular Ion”, Int. J. Hydrogen Energy, Vol. 27, No. 5, (2002), pp. 533-564; R. Mills, P. Ray, “Spectral Emission of Fractional Quantum Energy Levels of Atomic Hydrogen from a Helium-Hydrogen Plasma and the Implications for Dark Matter”, it. J. Hydrogen Energy, (2002), Vol. 27, No. 3, pp. 301-322; R. Mills, P. Ray, “Spectroscopic Identification of a Novel Catalytic Reaction of Potassium and Atomic Hydrogen and the Hydride Ion Product”, Int. J. Hydrogen Energy, Vol. 27, No. 2, (2002), pp. 183-192; R. Mills, “BlackLight Power Technology—A New Clean Hydrogen Energy Source with the Potential for Direct Conversion to Electricity”, Proceedings of the National Hydrogen Association, 12 th Annual U.S. Hydrogen Meeting and Exposition, Hydrogen: The Common Thread, The Washington Hilton and Towers, Washington D.C., (Mar. 6-8, 2001), pp. 611-697; R. Mills, W. Good, A. Voigt, Jinquan Dong, “Minimum Heat of Formation of Potassium Iodo Hydride”, Int. J. Hydrogen Energy, Vol. 26, No. 11, (2001), pp. 1199-1208; R. Mills, “Spectroscopic Identification of a Novel Catalytic Reaction of Atomic Hydrogen and the Hydride Ion Product”, Int. J. Hydrogen Energy, Vol. 26, No. 10, (2001), pp. 1041-1058; R. Mills, N. Greenig, S. Hicks, “Optically Measured Power Balances of Glow Discharges of Mixtures of Argon, Hydrogen, and Potassium, Rubidium, Cesium, or Strontium Vapor”, Int. J. Hydrogen Energy, Vol. 27, No. 6, (2002), pp. 651-670; R. Mills, “The Grand Unified Theory of Classical Quantum Mechanics”, Global Foundation, Inc. Orbis Scientiae entitled The Role of Attractive and Repulsive Gravitational Forces in Cosmic Acceleration of Particles The Origin of the Cosmic Gamma Ray Bursts, (29th Conference on High Energy Physics and Cosmology Since 1964) Dr. Behram N. Kursunoglu, Chairman, Dec. 14-17, 2000, Lago Mar Resort, Fort Lauderdale, Fla., Kluwer Academic/Plenum Publishers, New York, pp. 243-258; R. Mills, “The Grand Unified Theory of Classical Quantum Mechanics”, Int. J. Hydrogen Energy, Vol. 27, No. 5, (2002), pp. 565-590; R. Mills and M. Nansteel, P. Ray, “Argon-Hydrogen-Strontium Discharge Light Source”, IEEE Transactions on Plasma Science, Vol. 30, No. 2, (2002), pp. 639-653; R. Mills, B. Dhandapani, M. Nansteel, J. He, A. Voigt, “Identification of Compounds Containing Novel Hydride Ions by Nuclear Magnetic Resonance Spectroscopy”, Int. J. Hydrogen Energy, Vol. 26, No. 9, (2001), pp. 965-979; R. Mills, “BlackLight Power Technology—A New Clean Energy Source with the Potential for Direct Conversion to Electricity”, Global Foundation International Conference on “Global Warming and Energy Policy”, Dr. Behram N. Kursunoglu, Chairman, Fort Lauderdale, Fla., Nov. 26-28, 2000, Kluwer Academic/Plenum Publishers, New York, pp. 187-202; R. Mills, “The Nature of Free Electrons in Superfluid Helium—a Test of Quantum Mechanics and a Basis to Review its Foundations and Make a Comparison to Classical Theory”, Int. J. Hydrogen Energy, Vol. 26, No. 10, (2001), pp. 1059-1096; R. Mills, M. Nansteel, and P. Ray, “Excessively Bright Hydrogen-Strontium Plasma Light Source Due to Energy Resonance of Strontium with Hydrogen”, J. of Plasma Physics, Vol. 69, (2003), pp. 131-158; R. Mills, J. Dong, Y. Lu, “Observation of Extreme Ultraviolet Hydrogen Emission from Incandescently Heated Hydrogen Gas with Certain Catalysts”, Int. J. Hydrogen Energy, Vol. 25, (2000), pp. 919-943; R. Mills, “Observation of Extreme Ultraviolet Emission from Hydrogen-KI Plasmas Produced by a Hollow Cathode Discharge”, Int. J. Hydrogen Energy, Vol. 26, No. 6, (2001), pp. 579-592; R. Mills, “Temporal Behavior of Light-Emission in the Visible Spectral Range from a Ti—K2CO3-H-Cell”, Int. J. Hydrogen Energy, Vol. 26, No. 4, (2001), pp. 327-332; R. Mills, T. Onuma, and Y. Lu, “Formation of a Hydrogen Plasma from an Incandescently Heated Hydrogen-Catalyst Gas Mixture with an Anomalous Afterglow Duration”, Int. J. Hydrogen Energy, Vol. 26, No. 7, July, (2001), pp. 749-762; R. Mills, M. Nansteel, and Y. Lu, “Observation of Extreme Ultraviolet Hydrogen Emission from Incandescently Heated Hydrogen Gas with Strontium that Produced an Anomalous Optically Measured Power Balance”, Int. J. Hydrogen Energy, Vol. 26, No. 4, (2001), pp. 309-326; R. Mills, B. Dhandapani, N. Greenig, J. He, “Synthesis and Characterization of Potassium Iodo Hydride”, Int. J. of Hydrogen Energy, Vol. 25, Issue 12, December, (2000), pp. 1185-1203; R. Mills, “Novel Inorganic Hydride”, Int. J. of Hydrogen Energy, Vol. 25, (2000), pp. 669-683; R. Mills, B. Dhandapani, M. Nansteel, J. He, T. Shannon, A. Echezuria, “Synthesis and Characterization of Novel Hydride Compounds”, Int. J. of Hydrogen Energy, Vol. 26, No. 4, (2001), pp. 339-367; R. Mills, “Highly Stable Novel Inorganic Hydrides”, Journal of New Materials for Electrochemical Systems, Vol. 6, (2003), pp. 45-54; R. Mills, “Novel Hydrogen Compounds from a Potassium Carbonate Electrolytic Cell”, Fusion Technology, Vol. 37, No. 2, March, (2000), pp. 157-182; R. Mills, “The Hydrogen Atom Revisited”, Int. J. of Hydrogen Energy, Vol. 25, Issue 12, December, (2000), pp. 1171-1183; Mills, R., Good, W., “Fractional Quantum Energy Levels of Hydrogen”, Fusion Technology, Vol. 28, No. 4, November, (1995), pp. 1697-1719; Mills, R., Good, W., Shaubach, R., “Dihydrino Molecule Identification”, Fusion Technology, Vol. 25, 103 (1994); R. Mills and S. Kneizys, Fusion Technol. Vol. 20, 65 (1991); prior U.S. Provisional Patent Applications Ser. No. 60/343,585, filed Jan. 2, 2002; 60/352,880, filed Feb. 1, 2002; Ser. No. 60/361,337, filed Mar. 5, 2002; Ser. No. 60/365,176, filed Mar. 19, 2002; Ser. No. 60/367,476, filed Mar. 27, 2002; Ser. No. 60/376,546, filed May 1, 2002; Ser. No. 60/380,846, filed May 17, 2002; and Ser. No. 60/385,892, filed Jun. 6, 2002; Ser. No. 60/095,149, filed Aug. 3, 1998; Ser. No. 60/101,651, filed Sep. 24, 1998; Ser. No. 60/105,752, filed Oct. 26, 1998; Ser. No. 60/113,713, filed Dec. 24, 1998; Ser. No. 60/123,835, filed Mar. 11, 1999; Ser. No. 60/130,491, filed Apr. 22, 1999; Ser. No. 60/141,036, filed Jun. 29, 1999; Ser. No. 60/053,378 filed Jul. 22, 1997; Ser. No. 60/068,913 filed Dec. 29, 1997; Ser. No. 60/090,239 filed Jun. 22, 1998; Ser. No. 60/053,307 filed Jul. 22, 1997; Ser. No. 60/068,918 filed Dec. 29, 1997; Ser. No. 60/080,725 filed Apr. 3, 1998; Ser. No. 60/063,451 filed Oct. 29, 1997; Ser. No. 60/074,006 filed Feb. 9, 1998; Ser. No. 60/080,647 filed Apr. 3, 1998; in prior PCT applications PCT/US02/35872; PCT/US02/06945; PCT/US02/06955; PCT/US01/09055; PCT/US01/25954; PCT/US00/20820; PCT/US00/20819; PCT/US00/09055; PCT/US99/17171; PCT/US99/17129; PCT/US 98/22822; PCT/US98/14029; PCT/US96/07949; PCT/US94/02219; PCT/US91/08496; PCT/US90/01998; and PCT/US89/05037; prior U.S. patent application Ser. No. 10/319,460, filed Nov. 27, 2002; Ser. No. 09/813,792, filed Mar. 22, 2001; Ser. No. 09/678,730, filed Oct. 4, 2000; Ser. No. 09/513,768, filed Feb. 25, 2000; Ser. No. 09/501,621, filed Feb. 9, 2000; Ser. No. 09/501,622, filed Feb. 9, 2000; Ser. No. 09/362,693, filed Jul. 29, 1999; Ser. No. 09/225,687, filed on Jan. 6, 1999; Ser. No. 09/009,294 filed Jan. 20, 1998; Ser. No. 09/111,160 filed Jul. 7, 1998; Ser. No. 09/111,170 filed Jul. 7, 1998; Ser. No. 09/111,016 filed Jul. 7, 1998; Ser. No. 09/111,003 filed Jul. 7, 1998; Ser. No. 09/110,694 filed Jul. 7, 1998; Ser. No. 09/110,717 filed Jul. 7, 1998; Ser. No. 09/009,455 filed Jan. 20, 1998; Ser. No. 09/110,678 filed Jul. 7, 1998; Ser. No. 09/181,180 filed Oct. 28, 1998; Ser. No. 09/008,947 filed Jan. 20, 1998; Ser. No. 09/009,837 filed Jan. 20, 1998; Ser. No. 08/822,170 filed Mar. 27, 1997; Ser. No. 08/592,712 filed Jan. 26, 1996; Ser. No. 08/467,051 filed on Jun. 6, 1995; Ser. No. 08/416,040 filed on Apr. 3, 1995; Ser. No. 08/467,911 filed on Jun. 6, 1995; Ser. No. 08/107,357 filed on Aug. 16, 1993; Ser. No. 08/075,102 filed on Jun. 11, 1993; Ser. No. 07/626,496 filed on Dec. 12, 1990; Ser. No. 07/345,628 filed Apr. 28, 1989; Ser. No. 07/341,733 filed Apr. 21, 1989; and U.S. Pat. No. 6,024,935; the entire disclosures of which are all incorporated herein by reference; (hereinafter “Mills Prior Publications”).

The binding energy of an atom, ion, or molecule, also known as the ionization energy, is the energy required to remove one electron from the atom, ion or molecule. A hydrogen atom having the binding energy given in Eq. (1) is hereafter referred to as a hydrino atom or hydrino. The designation for a hydrino of radius

$$\frac{{α}_{H}}{p} ,$$

where a_{H} is the radius of an ordinary hydrogen atom and p is an integer, is

$$H [ \frac{{α}_{H}}{p} ] .$$

A hydrogen atom with a radius a_{H} is hereinafter referred to as “ordinary hydrogen atom” or “normal hydrogen atom.” Ordinary atomic hydrogen is characterized by its binding energy of 13.6 eV.

2.2 Catalysts

Catalysts of the present invention to generate power, plasma, light such as high energy light, extreme ultraviolet light, and ultraviolet light, and novel hydrogen species and compositions of matter comprising new forms of hydrogen via the catalysis of atomic hydrogen are disclosed in “Mills Prior Publications”. Hydrinos are formed by reacting an ordinary hydrogen atom with a catalyst having a net enthalpy of reaction of about
m·27.2 eV (2a)
where m is an integer. This catalyst has also been referred to as an energy hole or source of energy hole in Mills earlier filed Patent Applications. It is believed that the rate of catalysis is increased as the net enthalpy of reaction is more closely matched to m·27.2 eV. It has been found that catalysts having a net enthalpy of reaction within ±10%, preferably ±5%, of m·27.2 eV are suitable for most applications.

In another embodiment, the catalyst to form hydrinos has a net enthalpy of reaction of about
m/2·27.2 eV (2b)
where m is an integer greater that one. It is believed that the rate of catalysis is increased as the net enthalpy of reaction is more closely matched to m/2·27.2 eV. It has been found that catalysts having a net enthalpy of reaction within ±10%, preferably ±5%, of m/2·27.2 eV are suitable for most applications. The catalyst may comprise at least one molecule selected from the group of C₂, N₂, O₂, CO₂, NO₂, and NO₃ and/or at least one atom or ion selected from the group of Li, Be, K, Ca, Ti, V, Cr, Mn, Fe, Co, Ni, Cu, Zn, As, Se, Kr, Rb, Sr, Nb, Mo, Pd, Sn, Te, Cs, Ce, Pr, Sm, Gd, Dy, Pb, Pt, Kr, 2K⁺, He⁺, Na⁺, Rb⁺, Sr⁺, Fe³⁺, Mo²⁺, Mo⁴⁺, In³⁺, He⁺, Ar⁺, Xe⁺, Ar²⁺ and H⁺, Ne⁺ and H⁺, Ne₂*, He₂*, 2H, and H(1/p).

2.3 Hydrinos

Novel hydrogen species and compositions of matter comprising new forms of hydrogen formed by the catalysis of atomic hydrogen are disclosed in “Mills Prior Publications”. The novel hydrogen compositions of matter comprise:

(a) at least one neutral, positive, or negative hydrogen species (hereinafter “increased binding energy hydrogen species”) having a binding energy
(i) greater than the binding energy of the corresponding ordinary hydrogen species, or
(ii) greater than the binding energy of any hydrogen species for which the corresponding ordinary hydrogen species is unstable or is not observed because the ordinary hydrogen species' binding energy is less than thermal energies at ambient conditions (standard temperature and pressure, STP), or is negative; and

(b) at least one other element. The compounds of the invention are hereinafter referred to as “increased binding energy hydrogen compounds”.

By “other element” in this context is meant an element other than an increased binding energy hydrogen species. Thus, the other element can be an ordinary hydrogen species, or any element other than hydrogen. In one group of compounds, the other element and the increased binding energy hydrogen species are neutral. In another group of compounds, the other element and increased binding energy hydrogen species are charged such that the other element provides the balancing charge to form a neutral compound. The former group of compounds is characterized by molecular and coordinate bonding; the latter group is characterized by ionic bonding.

Also provided are novel compounds and molecular ions comprising

(a) at least one neutral, positive, or negative hydrogen species (hereinafter “increased binding energy hydrogen species”) having a total energy
(i) greater than the total energy of the corresponding ordinary hydrogen species, or
(ii) greater than the total energy of any hydrogen species for which the corresponding ordinary hydrogen species is unstable or is not observed because the ordinary hydrogen species' total energy is less than thermal energies at ambient conditions, or is negative; and

(b) at least one other element.

The total energy of the hydrogen species is the sum of the energies to remove all of the electrons from the hydrogen species. The hydrogen species according to the present invention has a total energy greater than the total energy of the corresponding ordinary hydrogen species. The hydrogen species having an increased total energy according to the present invention is also referred to as an “increased binding energy hydrogen species” even though some embodiments of the hydrogen species having an increased total energy may have a first electron binding energy less that the first electron binding energy of the corresponding ordinary hydrogen species. For example, the hydride ion of Eq. (3) for p=24 has a first binding energy that is less than the first binding energy of ordinary hydride ion, while the total energy of the hydride ion of Eq. (3) for p=24 is much greater than the total energy of the corresponding ordinary hydride ion.

Also provided are novel compounds and molecular ions comprising

(a) a plurality of neutral, positive, or negative hydrogen species (hereinafter “increased binding energy hydrogen species”) having a binding energy
(i) greater than the binding energy of the corresponding ordinary hydrogen species, or
(ii) greater than the binding energy of any hydrogen species for which the corresponding ordinary hydrogen species is unstable or is not observed because the ordinary hydrogen species' binding energy is less than thermal energies at ambient conditions or is negative; and

(b) optionally one other element. The compounds of the invention are hereinafter referred to as “increased binding energy hydrogen compounds”.

The increased binding energy hydrogen species can be formed by reacting one or more hydrino atoms with one or more of an electron, hydrino atom, a compound containing at least one of said increased binding energy hydrogen species, and at least one other atom, molecule, or ion other than an increased binding energy hydrogen species.

Also provided are novel compounds and molecular ions comprising

(a) a plurality of neutral, positive, or negative hydrogen species (hereinafter “increased binding energy hydrogen species”) having a total energy
(i) greater than the total energy of ordinary molecular hydrogen, or
(ii) greater than the total energy of any hydrogen species for which the corresponding ordinary hydrogen species is unstable or is not observed because the ordinary hydrogen species' total energy is less than thermal energies at ambient conditions or is negative; and

(b) optionally one other element. The compounds of the invention are hereinafter referred to as “increased binding energy hydrogen compounds”.

In an embodiment, a compound is provided, comprising at least one increased binding energy hydrogen species selected from the group consisting of (a) hydride ion having a binding energy according to Eq. (3) that is greater than the binding of ordinary hydride ion (about 0.8 eV) for p=2 up to 23, and less for p=24 (“increased binding energy hydride ion” or “hydrino hydride ion”); (b) hydrogen atom having a binding energy greater than the binding energy of ordinary hydrogen atom (about 13.6 eV) (“increased binding energy hydrogen atom” or “hydrino”); (c) hydrogen molecule having a first binding energy greater than about 15.3 eV (“increased binding energy hydrogen molecule” or “dihydrino”); and (d) molecular hydrogen ion having a binding energy greater than about 16.3 eV (“increased binding energy molecular hydrogen ion” or “dihydrino molecular ion”).

According to the present invention, a hydrino hydride ion (H⁻) having a binding energy according to Eq. (3) that is greater than the binding of ordinary hydride ion (about 0.8 eV) for p=2 up to 23, and less for p=24 (H⁻) is provided. For p=2 to p=24 of Eq. (3), the hydride ion binding energies are respectively 3, 6.6, 11.2, 16.7, 22.8, 29.3, 36.1, 42.8, 49.4, 55.5, 61.0, 65.6, 69.2, 71.6, 72.4, 71.6, 68.8, 64.0, 56.8, 47.1, 34.7, 19.3, and 0.69 eV. Compositions comprising the novel hydride ion are also provided.

The binding energy of the novel hydrino hydride ion can be represented by the following formula:

$$\begin{matrix}Binding Energy = \frac{{ℏ}^{2} \sqrt{s ( s + 1 )}}{8 {μ}_{e} {{a}_{0}^{2} [ \frac{1 + \sqrt{s ( s + 1 )}}{p} ]}^{2}} - \\ \frac{{πμ}_{0} {e}^{2} {ℏ}^{2}}{{m}_{e}^{2}} ( \frac{1}{{a}_{H}^{3}} + \frac{{2}^{2}}{{{a}_{0}^{3} [ \frac{1 + \sqrt{s ( s + 1 )}}{p} ]}^{3}} )\end{matrix} \qquad ( 3 )$$

where p is an integer greater than one, s=½, π is pi, \overline{h} is Planck's constant bar, μₒ is the permeability of vacuum, mₑ is the mass of the electron, μₑ is the reduced electron mass given by

$${μ}_{e} = \frac{{m}_{e} {m}_{p}}{\frac{{m}_{e}}{\sqrt{\frac{3}{4}}} + {m}_{p}}$$

where mₚ is the mass of the proton, a_{H} is the radius of the hydrogen atom, aₒ is the Bohr radius, and e is the elementary charge. The radii are given by

$${r}_{2} = {r}_{1} = {a}_{0} ( 1 + \sqrt{s ( s + 1 )} ) s = \frac{1}{2} \qquad ( 4 )$$

The hydrino hydride ion of the present invention can be formed by the reaction of an electron source with a hydrino, that is, a hydrogen atom having a binding energy of about

$$\frac{13.6 eV}{{n}^{2}} ,$$

where

$$n = \frac{1}{p}$$

and p is an integer greater than 1. The hydrino hydride ion is represented by H⁻ (n=1/p) or H⁻ (1/p):

$$\begin{matrix}H [ \frac{{α}_{H}}{p} ] + {e}^{-} -> {H}^{-} ( n = 1 / p ) & ( 5 a ) \\ H [ \frac{{α}_{H}}{p} ] + {e}^{-} -> {H}^{-} ( 1 / p ) & ( 5 b )\end{matrix}$$

The hydrino hydride ion is distinguished from an ordinary hydride ion comprising an ordinary hydrogen nucleus and two electrons having a binding energy of about 0.8 eV. The latter is hereafter referred to as “ordinary hydride ion” or “normal hydride ion” The hydrino hydride ion comprises a hydrogen nucleus including proteum, deuterium, or tritium, and two indistinguishable electrons at a binding energy according to Eq. (3).

Novel compounds are provided comprising one or more hydrino hydride ions and one or more other elements. Such a compound is referred to as a hydrino hydride compound.

Ordinary hydrogen species are characterized by the following binding energies (a) hydride ion, 0.754 eV (“ordinary hydride ion”); (b) hydrogen atom (“ordinary hydrogen atom”), 13.6 eV; (c) diatomic hydrogen molecule, 15.3 eV (“ordinary hydrogen molecule”); (d) hydrogen molecular ion, 16.3 eV (“ordinary hydrogen molecular ion”); and (e) H₃⁺, 22.6 eV (“ordinary trihydrogen molecular ion”). Herein, with reference to forms of hydrogen, “normal” and “ordinary” are synonymous.

According to a further embodiment of the invention, a compound is provided comprising at least one increased binding energy hydrogen species such as (a) a hydrogen atom having a binding energy of about

$$\frac{13.6 eV}{{( \frac{1}{p} )}^{2}} ,$$

preferably within ±10%, more preferably ±5%, where p is an integer, preferably an integer from 2 to 137; (b) a hydride ion (H⁻) having a binding energy of about

$$Binding Energy = \frac{{ℏ}^{2} \sqrt{s ( s + 1 )}}{8 {μ}_{e} {{a}_{0}^{2} [ \frac{1 + \sqrt{s ( s + 1 )}}{p} ]}^{2}} - \frac{{πμ}_{0} {ⅇ}^{2} {ℏ}^{2}}{{m}_{e}^{2}} ( \frac{1}{{a}_{H}^{3}} + \frac{{2}^{2}}{{{a}_{0}^{3} [ \frac{1 + \sqrt{s ( s + 1 )}}{p} ]}^{3}} ) ,$$

preferably within ±10%, more preferably ±5%, where p is an integer, preferably an integer from 2 to 24; (c) H₄⁺ (1/p); (d) a trihydrino molecular ion, H₃⁺ (1/p), having a binding energy of about

$$\frac{22.6}{{( \frac{1}{p} )}^{2}} e V$$

preferably within ±10%, more preferably ±5%, where p is an integer, preferably an integer from 2 to 137; (e) a dihydrino having a binding energy of about

$$\frac{15.3}{{( \frac{1}{p} )}^{2}} e V$$

preferably within ±10%, more preferably ±5%, where p is an integer, preferably and integer from 2 to 137; (f) a dihydrino molecular ion with a binding energy of about

$$\frac{16.3}{{( \frac{1}{p} )}^{2}} e V$$

preferably within ±10%, more preferably ±5%, where p is an integer, preferably an integer from 2 to 137.

According to a further preferred embodiment of the invention, a compound is provided comprising at least one increased binding energy hydrogen species such as (a) a dihydrino molecular ion having a total energy of

$$\begin{matrix}{E}_{T} = - {p}^{2} \{ \begin{matrix}\frac{{ⅇ}^{2}}{8 {πɛ}_{0} {a}_{H}} ( 4 ln 3 - 1 - 2 ln 3 ) \\ [ 1 + p \sqrt{\frac{2 ℏ \sqrt{\frac{2 {ⅇ}^{2}}{\frac{4 {{πɛ}_{0} ( 2 {a}_{H} )}^{3}}{{m}_{e}}}}}{{m}_{e} {c}^{2}}} ] - \frac{1}{2} ℏ \sqrt{\frac{k}{μ}}\end{matrix} \} \\ = - {p}^{2} 16.13392 e V - {p}^{3} 0.118755 eV\end{matrix} \qquad ( 6 )$$

preferably within ±10%, more preferably ±5%, where p is an integer, \overline{h} is Planck's constant bar, mₑ is the mass of the electron, c is the speed of light in vacuum, μ is the reduced nuclear mass, and k is the harmonic force constant solved previously [R. L. Mills, “The Nature of the Chemical Bond Revisited and an Alternative Maxwellian Approach”, submitted. Posted at http://www.blacklightpower.com/pdf/technical/H2 PaperTableFiguresCaptions111303.pdf which is incorporated by reference] and (b) a dihydrino molecule having a total energy of

$$\begin{matrix}{E}_{T} = - {p}^{2} \{ \begin{matrix}\frac{{ⅇ}^{2}}{8 {πɛ}_{0} {a}_{0}} [ ( 2 \sqrt{2} - \sqrt{2} + \frac{\sqrt{2}}{2} ) ln \frac{\sqrt{2} + 1}{\sqrt{2} - 1} - \sqrt{2} ] \\ 1 + [ p \sqrt{\frac{2 ℏ \sqrt{\frac{{ⅇ}^{2}}{\frac{4 {πɛ}_{0} {a}_{0}^{3}}{{m}_{e}}}}}{{m}_{e} {c}^{2}}} ] - \frac{1}{2} ℏ \sqrt{\frac{k}{μ}}\end{matrix} \} \\ = - {p}^{2} 31.351 e V - {p}^{3} 0.326469 eV\end{matrix} \qquad ( 7 )$$

preferably within ±10%, more preferably ±5%, where p is an integer and aₒ is the Bohr radius.

According to one embodiment of the invention wherein the compound comprises a negatively charged increased binding energy hydrogen species, the compound further comprises one or more cations, such as a proton, ordinary H₂⁺, or ordinary H₃⁺.

A method is provided for preparing compounds comprising at least one increased binding energy hydride ion. Such compounds are hereinafter referred to as “hydrino hydride compounds”. The method comprises reacting atomic hydrogen with a catalyst having a net enthalpy of reaction of about

$$\frac{m}{2} \cdot 27 e V ,$$

where m is an integer greater than 1, preferably an integer less than 400, to produce an increased binding energy hydrogen atom having a binding energy of about

$${\frac{13.6 e V}{{( \frac{1}{p} )}^{2}}}^{17}$$

where p is an integer, preferably an integer from 2 to 137. A further product of the catalysis is energy. The increased binding energy hydrogen atom can be reacted with an electron source, to produce an increased binding energy hydride ion. The increased binding energy hydride ion can be reacted with one or more cations to produce a compound comprising at least one increased binding energy hydride ion.

### II. SUMMARY OF THE INVENTION

An object of the present invention is to generate power and novel hydrogen species and compositions of matter comprising new forms of hydrogen via the catalysis of atomic hydrogen.

Another objective of the present invention is to generate a plasma and a source of light such as high energy light, extreme ultraviolet light and ultraviolet light, via the catalysis of atomic hydrogen.

Another objective of the present invention is to optimize the power balance by maximizing the output power from the hydrogen catalysis reaction while minimizing a pulsed or intermittent input power by controlling the parameters of the input power to initiate or at least partially maintain the plasma such as power density, pulse frequency, duty cycle, and peak and offset electric fields.

The above objectives and other objectives are achieved by the present invention comprising a plasma reactor to generate power and novel hydrogen species and compositions of matter comprising new forms of hydrogen via the catalysis of atomic hydrogen and to generate a plasma and a source of light such as high energy light, extreme ultraviolet light, and ultraviolet light, via the catalysis of atomic hydrogen. The reactor comprises a plasma forming energy cell for the catalysis of atomic hydrogen to form novel hydrogen species and compositions of matter comprising new forms of hydrogen, a source of catalyst for catalyzing the reaction of atomic hydrogen to form lower-energy hydrogen and release energy, a source of atomic hydrogen, and a source of intermittent or pulsed power to at least partially maintain the plasma. The cell comprises at least one of the group of a microwave cell, plasma torch cell, radio frequency (RF) cell, glow discharge cell, barrier electrode cell, plasma electrolysis cell, a pressurized gas cell, filament cell or rt-plasma cell, and a combination of at least one of a glow discharge cell, a microwave cell, and an RF plasma cell that are disclosed in “Mills Prior Publications”. The power balance is optimized by maximizing the output power from the hydrogen catalysis reaction while minimizing the input power by controlling the parameters of the input power to initiate or at least partially maintain the plasma such as the power density, pulse frequency, duty cycle, and peak and offset electric fields.

The intermittent or pulsed power source may provide a time period wherein the field is set to a desired strength by an offset DC, audio, RF, or microwave voltage or electric and magnetic fields. The field may be set to a desired strength during a time period by an offset DC, audio, RF, or microwave voltage or electric and magnetic fields that is below that required to maintain a discharge. The desired field strength during a low-field or nondischarge period may optimize the energy match between the catalyst and the atomic hydrogen. The intermittent or pulsed power source may further comprise a means to adjust the pulse frequency and duty cycle to optimize the power balance. The pulse frequency and duty cycle may be adjusted to optimize the power balance by optimizing the reaction rate versus the input power. The pulse frequency and duty cycle may be adjusted to optimize the power balance by optimizing the reaction rate versus the input power by controlling the amount of catalyst and atomic hydrogen generated by the discharge decay during the low-field or nondischarge period wherein the concentrations are dependent on the pulse frequency, duty cycle, and the rate of plasma decay.

### III. BRIEF DESCRIPTION OF THE DRAWINGS

FIG. 1 is a schematic drawing of a plasma electrolytic cell reactor in accordance with the present invention;

FIG. 2 is a schematic drawing of a gas cell reactor in accordance with the present invention;

FIG. 3 is a schematic drawing of a gas discharge cell reactor in accordance with the present invention;

FIG. 4 is a schematic drawing of a RF barrier electrode gas discharge cell reactor in accordance with the present invention;

FIG. 5 is a schematic drawing of a plasma torch cell reactor in accordance with the present invention;

FIG. 6 is a schematic drawing of another plasma torch cell reactor in accordance with the present invention, and

FIG. 7 is a schematic drawing of a microwave gas cell reactor in accordance with the present invention.

### IV. DETAILED DESCRIPTION OF THE INVENTION

1. Plasma Reactor

A plasma cell to generate power and novel hydrogen species and compositions of matter comprising new forms of hydrogen via the catalysis of atomic hydrogen and to generate a plasma and a source of light such as high energy light, extreme ultraviolet light and ultraviolet light, via the catalysis of atomic hydrogen described in “Mills Prior Publications” may be at least one of the group of a microwave cell, plasma torch cell, radio frequency (RF) cell, glow discharge cell, barrier electrode cell, plasma electrolysis cell, a pressurized gas cell, filament cell or rt-plasma cell, and a combination of at least one of a glow discharge cell, a microwave cell, and an RF plasma cell. Each of these cells comprises: a plasma forming energy cell for the catalysis of atomic hydrogen to form novel hydrogen species and compositions of matter comprising new forms of hydrogen, a source catalyst to form solid, molten, liquid, or gaseous catalyst, a source of atomic hydrogen, and a source of intermittent or pulsed power to at least partially maintain the plasma. As used herein and as contemplated by the subject invention, the term “hydrogen”, unless specified otherwise, includes not only proteum (¹H), but also deuterium (²H) and tritium (³H).

The following preferred embodiments of the invention disclose numerous property ranges, including but not limited to, pressure, flow rates, gas mixtures, voltage, current, pulsing frequency, power density, peak power, duty cycle, and the like, which are merely intended as illustrative examples. Based on the detailed written description, one skilled in the art would easily be able to practice this invention within other property ranges to produce the desired result without undue experimentation.

1.1 Plasma Electrolysis Cell Hydride Reactor

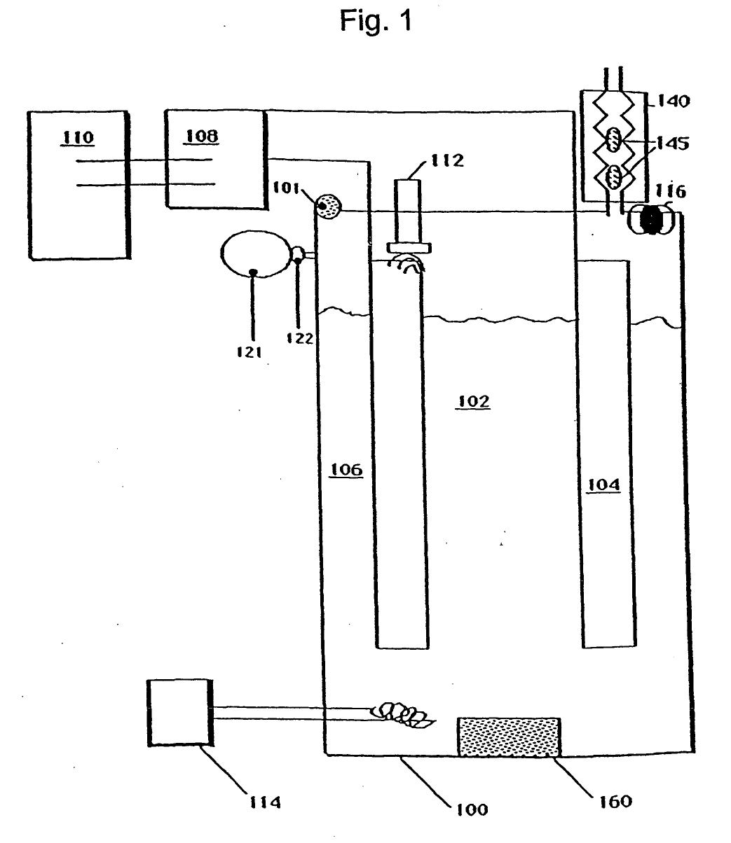

A plasma electrolytic reactor of the present invention comprises an electrolytic cell including a molten electrolytic cell. The electrolytic cell 100 is shown generally in FIG. 1. An electric current is passed through the electrolytic solution 102 having a catalyst by the application of a voltage to an anode 104 and cathode 106 by the power controller 108 powered by the power supply 110. Ultrasonic or mechanical energy may also be imparted to the cathode 106 and electrolytic solution 102 by vibrating means 112. Heat can be supplied to the electrolytic solution 102 by heater 114. The pressure of the electrolytic cell 100 can be controlled by pressure regulator means 116 where the cell can be closed. The reactor further comprises a means 101 that removes the (molecular) lower-energy hydrogen such as a selective venting valve.

In an embodiment, the electrolytic cell is further supplied with hydrogen from hydrogen source 121 where the over pressure can be controlled by pressure control means 122 and 116. The reaction vessel may be closed except for a connection to a condensor 140 on the top of the vessel 100. The cell may be operated at a boil such that the steam evolving from the boiling electrolyte 102 can be condensed in the condensor 140, and the condensed water can be returned to the vessel 100. The lower-energy state hydrogen can be vented through the top of the condensor 140. In one embodiment, the condensor contains a hydrogen/oxygen recombiner 145 that contacts the evolving electrolytic gases. The hydrogen and oxygen are recombined, and the resulting water can be returned to the vessel 100.

A plasma forming electrolytic power cell and hydride reactor of the present invention for the catalysis of atomic hydrogen to form increased-binding-energy-hydrogen species and increased-binding-energy-hydrogen compounds comprises a vessel, a cathode, an anode, an electrolyte, a high voltage electrolysis power supply, and a catalyst capable of providing a net enthalpy of reaction of m/2·27.2±0.5 eV where m is an integer. Preferably m is an integer less than 400. In an embodiment, the voltage is in the range of about 10 V to 50 kV and the current density may be high such as in the range of about 1 to 100 A/cm² or higher. In an embodiment, K⁺ is reduced to potassium atom which serves as the catalyst. The cathode of the cell may be tungsten such as a tungsten rod, and the anode of cell of may be platinum. The catalyst of the cell may comprise at least one selected from the group of Li, Be, K, Ca, Ti, V, Cr, Mn, Fe, Co, Ni, Cu, Zn, As, Se, Kr, Rb, Sr, Nb, Mo, Pd, Sn, Te, Cs, Ce, Pr, Sm, Gd, Dy, Pb, Pt, He⁺, Na⁺, Rb⁺, Fe³⁺, Mo²⁺, Mo⁴⁺, and In³⁺. The catalyst of the cell of may be formed from a source of catalyst. A reductant or other element 160 extraneous to the operation of the cell may be added to form increased binding energy hydrogen compounds.

1.2 Gas Cell Reactor

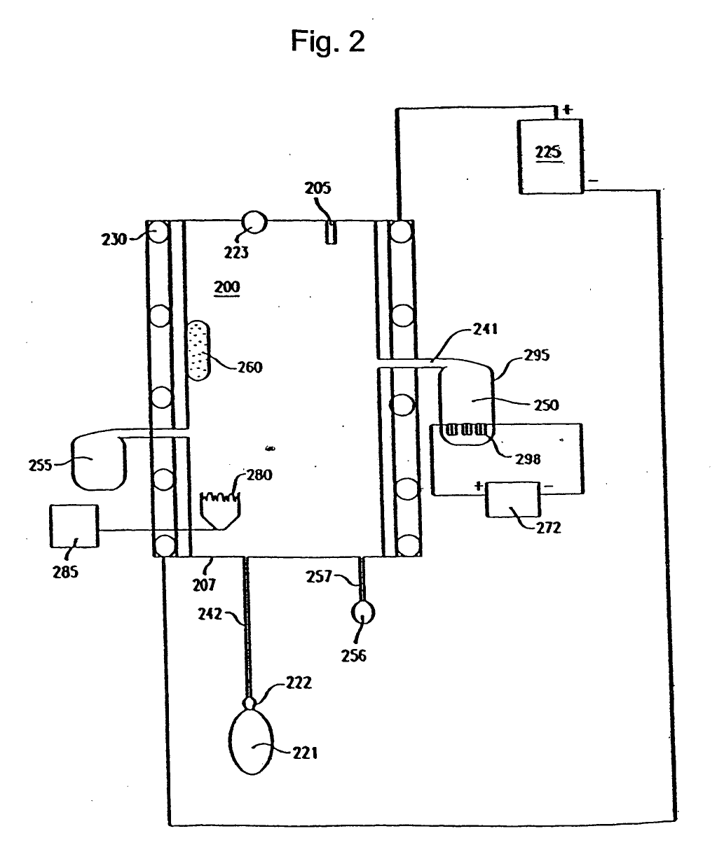

A gas cell reactor of the present invention is shown in FIG. 2 comprises a reaction vessel 207 having a chamber 200 capable of containing a vacuum or pressures greater than atmospheric. A source of hydrogen 221 communicating with chamber 200 delivers hydrogen to the chamber through hydrogen supply passage 242. A controller 222 is positioned to control the pressure and flow of hydrogen into the vessel through hydrogen supply passage 242. A pressure sensor 223 monitors pressure in the vessel. A vacuum pump 256 is used to evacuate the chamber through a vacuum line 257.

A catalyst 250 for generating hydrino atoms can be placed in a catalyst reservoir 295. The reaction vessel 207 has a catalyst supply passage 241 for the passage of gaseous catalyst from the catalyst reservoir 295 to the reaction chamber 200. Alternatively, the catalyst may be placed in a chemically resistant open container, such as a boat, inside the reaction vessel.

The molecular and atomic hydrogen partial pressures in the reactor vessel 207, as well as the catalyst partial pressure, is preferably maintained in the range of about 10 millitorr to about 100 torr. Most preferably, the hydrogen partial pressure in the reaction vessel 207 is maintained at about 200 millitorr.

Molecular hydrogen may be dissociated in the vessel into atomic hydrogen by a dissociating material. The dissociating material may comprise, for example, a noble metal such as platinum or palladium, a transition metal such as nickel and titanium, an inner transition metal such as niobium and zirconium, or a refractory metal such as tungsten or molybdenum. The dissociating material may also be maintained at elevated temperature by temperature control means 230, which may take the form of a heating coil as shown in cross section in FIG. 2. The heating coil is powered by a power supply 225. Molecular hydrogen may be dissociated into atomic hydrogen by application of electromagnetic radiation, such as UV light provided by a photon source 205. Molecular hydrogen may be dissociated into atomic hydrogen by a hot filament or grid 280 powered by power supply 285.

The catalyst vapor pressure is maintained at the desired pressure by controlling the temperature of the catalyst reservoir 295 with a catalyst reservoir heater 298 powered by a power supply 272. When the catalyst is contained in a boat inside the reactor, the catalyst vapor pressure is maintained at the desired value by controlling the temperature of the catalyst boat, by adjusting the boat's power supply.

The gas cell hydride reactor further comprises an electron source 260 in contact with the generated hydrinos to form hydrino hydride ions. The cell may further comprise a getter or cryotrap 255 to selectively collect the lower-energy-hydrogen species and/or the increased-binding-energy hydrogen compounds.

1.3 Gas Discharge Cell Reactor

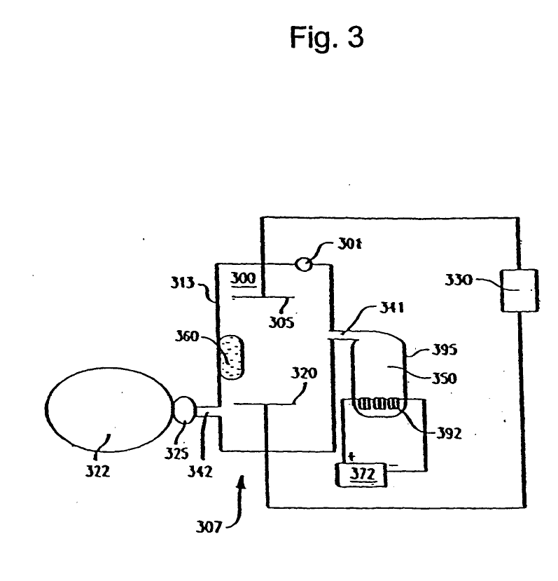

A gas discharge reactor of the present invention shown in FIG. 3 comprises a gas discharge cell 307 comprising a hydrogen isotope gas-filled glow discharge vacuum vessel 313 having a chamber 300. A hydrogen source 322 supplies hydrogen to the chamber 300 through control valve 325 via a hydrogen supply passage 342. A catalyst is contained in catalyst reservoir 395. A voltage and current source 330 causes current to pass between a cathode 305 and an anode 320. The current may be reversible. In another embodiment, the plasma is generated with a microwave source such as a microwave generator.

The discharge voltage may be in the range of about 1000 to about 50,000 volts. The current may be in the range of about 1 μA to about 1 A, preferably about 1 mA. The discharge current may be intermittent or pulsed. In an embodiment, an offset voltage is provided that is between, about 0.5 to about 500 V. In another embodiment, the offset voltage is set to provide a field of about 0.1 V/cm to about 50 V/cm. Preferably, the offset voltage is set to provide a field between about 1 V/cm to about 10 V/cm. The peak voltage may be in the range of about 1 V to 10 MV. More preferably, the peak voltage is in the range of about 10 V to 100 kV. Most preferably, the voltage is in the range of about 100 V to 500 V. In an embodiment, the pulse frequency is of about 0.1 Hz to about 100 MHz. In another embodiment, the pulse frequency is faster than the time for substantial atomic hydrogen recombination to molecular hydrogen. Preferably the frequency is within the range of about 1 to about 200 Hz. In an embodiment, the duty cycle is about 0.1% to about 95%. Preferably, the duty cycle is about 1% to about 50%.

In another embodiment, the power may be applied as an alternating current (AC). The frequency may be in the range of about 0.001 Hz to 1 GHz. More preferably the frequency is in the range of about 60 Hz to 100 MHz. Most preferably, the frequency is in the range of about 10 to 100 MHz. The system may comprises two electrodes wherein one or more electrodes are in direct contact with the plasma; otherwise, the electrodes may be separated from the plasma by a dielectric barrier. The peak voltage may be in the range of about 1 V to 10 MV. More preferably, the peak voltage is in the range of about 10 V to 100 kV. Most preferably, the voltage is in the range of about 100 V to 500 V.

In one embodiment of the gas discharge cell hydride reactor, the wall of vessel 313 is conducting and serves as the anode. In another embodiment, the cathode 305 is hollow such as a hollow, nickel, aluminum, copper, or stainless steel hollow cathode. In an embodiment, the cathode material may be a source of catalyst such as iron or samarium.

An embodiment of the gas discharge cell reactor where catalysis occurs in the gas phase utilizes a controllable gaseous catalyst. The gaseous hydrogen atoms for conversion to hydrinos are provided by a discharge of molecular hydrogen gas. The gas discharge cell 307 has a catalyst supply passage 341 for the passage of the gaseous catalyst 350 from catalyst reservoir 395 to the reaction chamber 300. The catalyst reservoir 395 is heated by a catalyst reservoir heater 392 having a power supply 372 to provide the gaseous catalyst to the reaction chamber 300. The catalyst vapor pressure is controlled by controlling the temperature of the catalyst reservoir 395, by adjusting the heater 392 by means of its power supply 372. The reactor further comprises a selective venting valve 301.

In another embodiment a chemically resistant open container, such as a tungsten or ceramic boat, positioned inside the gas discharge cell contains the catalyst. The catalyst in the catalyst boat is heated with a boat heater using by means of an associated power supply to provide the gaseous catalyst to the reaction chamber. Alternatively, the glow gas discharge cell is operated at an elevated temperature such that the catalyst in the boat is sublimed, boiled, or volatilized into the gas phase. The catalyst vapor pressure is controlled by controlling the temperature of the boat or the discharge cell by adjusting the heater with its power supply.

The gas discharge cell hydride reactor may further comprise an electron source 360 in contact with the generated hydrinos to form hydrino hydride ions.

1.4 Radio Frequency (RF) Barrier Electrode Discharge Cell Reactor

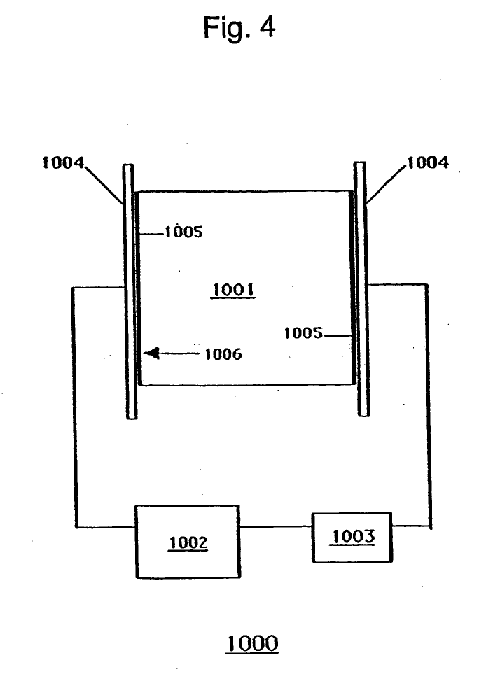

In an embodiment of the discharge cell reactor, at least one of the discharge electrodes is shielded by a dielectric barrier such as glass, quartz, Alumina, or ceramic in order to provide an electric field with minimum power dissipation. A radio frequency (RF) barrier electrode discharge cell system 1000 of the present invention is shown in FIG. 4. The RF power may be capacitively coupled. In an embodiment, the electrodes 1004 may be external to the cell 1001. A dielectric layer 1005 separates the electrodes from the cell wall 1006. The high driving voltage may be AC and may be high frequency. The driving circuit comprises a high voltage power source 1002 which is capable of providing RF and an impedance matching circuit 1003. The frequency is preferably in the range of about 100 Hz to about 10 GHz, more preferably, about 1 kHz to about 1 MHz, most preferably about 5-10 kHz. The voltage is preferably in the range of about 100 V to about 1 MV, more preferably about 1 kV to about 100 kV, and most preferably about 5 to about 10 kV.

1.5 Plasma Torch Cell Reactor

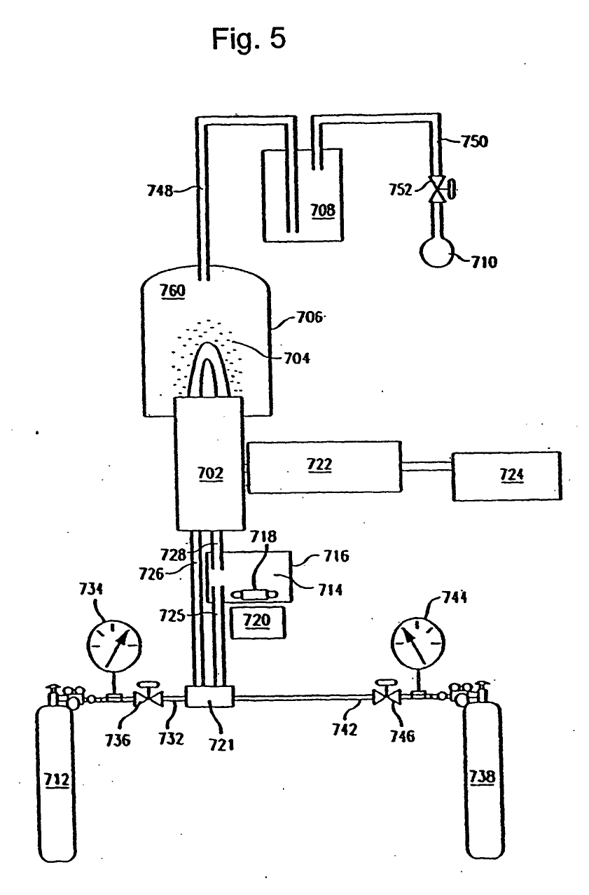

A plasma torch cell reactor of the present invention is shown in FIG. 5. A plasma torch 702 provides a hydrogen isotope plasma 704 enclosed by a manifold 706 and contained in plasma chamber 760. Hydrogen from hydrogen supply 738 and plasma gas from plasma gas supply 712, along with a catalyst 714 for forming hydrinos and energy, is supplied to torch 702. The plasma may comprise argon, for example. The catalyst may be contained in a catalyst reservoir 716. The reservoir is equipped with a mechanical agitator, such as a magnetic stirring bar 718 driven by magnetic stirring bar motor 720. The catalyst is supplied to plasma torch 702 through passage 728. The catalyst may be generated by a microwave discharge. Preferred catalysts are He⁺, Ne⁺, or Ar⁺ from a source such as helium, neon, or argon gas. The source of catalyst may be helium, helium, neon, neon-hydrogen mixture, or argon to form He⁺, He₂*, Ne₂*, Ne⁺/H⁺ or Ar⁺, respectively.

Hydrogen is supplied to the torch 702 by a hydrogen passage 726. Alternatively, both hydrogen and catalyst may be supplied through passage 728. The plasma gas is supplied to the torch by a plasma gas passage 726. Alternatively, both plasma gas and catalyst may be supplied through passage 728.

Hydrogen flows from hydrogen supply 738 to a catalyst reservoir 716 via passage 742. The flow of hydrogen is controlled by hydrogen flow controller 744 and valve 746. Plasma gas flows from the plasma gas supply 712 via passage 732. The flow of plasma gas is controlled by plasma gas flow controller 734 and valve 736. A mixture of plasma gas and hydrogen is supplied to the torch via passage 726 and to the catalyst reservoir 716 via passage 725. The mixture is controlled by hydrogen-plasma-gas mixer and mixture flow regulator 721. The hydrogen and plasma gas mixture serves as a carrier gas for catalyst particles which are dispersed into the gas stream as fine particles by mechanical agitation. The aerosolized catalyst and hydrogen gas of the mixture flow into the plasma torch 702 and become gaseous hydrogen atoms and vaporized catalyst ions (such as Rb⁺ ions from a salt of rubidium) in the plasma 704. The plasma is powered by a microwave generator 724 wherein the microwaves are tuned by a tunable microwave cavity 722. Catalysis may occur in the gas phase.

Hydrino atoms and hydrino hydride ions are produced in the plasma 704. Hydrino hydride compounds are cryopumped onto the manifold 706, or they flow into hydrino hydride compound trap 708 through passage 748. Trap 708 communicates with vacuum pump 710 through vacuum line 750 and valve 752. A flow to the trap 708 is effected by a pressure gradient controlled by the vacuum pump 710, vacuum line 750, and vacuum valve 752.

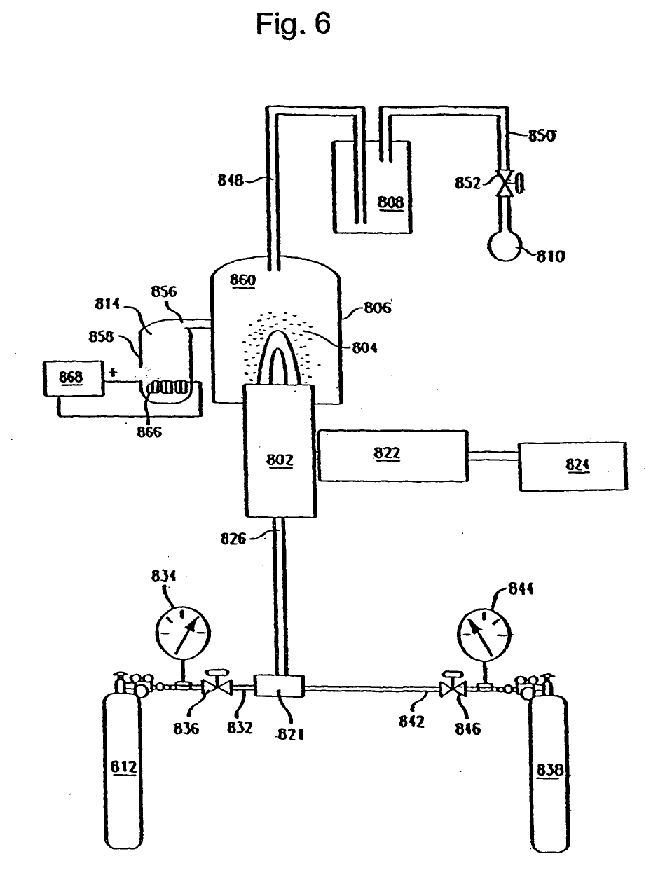

In another embodiment of the plasma torch cell hydride reactor shown in FIG. 6, at least one of plasma torch 802 or manifold 806 has a catalyst supply passage 856 for passage of the gaseous catalyst from a catalyst reservoir 858 to the plasma 804. The catalyst 814 in the catalyst reservoir 858 is heated by a catalyst reservoir heater 866 having a power supply 868 to provide the gaseous catalyst to the plasma 804. The catalyst vapor pressure can be controlled by controlling the temperature of the catalyst reservoir 858 by adjusting the heater 866 with its power supply 868. The remaining elements of FIG. 6 have the same structure and function of the corresponding elements of FIG. 5. In other words, element 812 of FIG. 6 is a plasma gas supply corresponding to the plasma gas supply 712 of FIG. 5, element 838 of FIG. 6 is a hydrogen supply corresponding to hydrogen supply 738 of FIG. 5, and so forth.

In another embodiment of the plasma torch cell hydride reactor, a chemically resistant open container such as a ceramic boat located inside the manifold contains the catalyst. The plasma torch manifold forms a cell which can be operated at an elevated temperature such that the catalyst in the boat is sublimed, boiled, or volatilized into the gas phase. Alternatively, the catalyst in the catalyst boat can be heated with a boat heater having a power supply to provide the gaseous catalyst to the plasma. The catalyst vapor pressure can be controlled by controlling the temperature of the cell with a cell heater, or by controlling the temperature of the boat by adjusting the boat heater with an associated power supply.

1.6. Microwave Gas Cell Hydride and Power Reactor

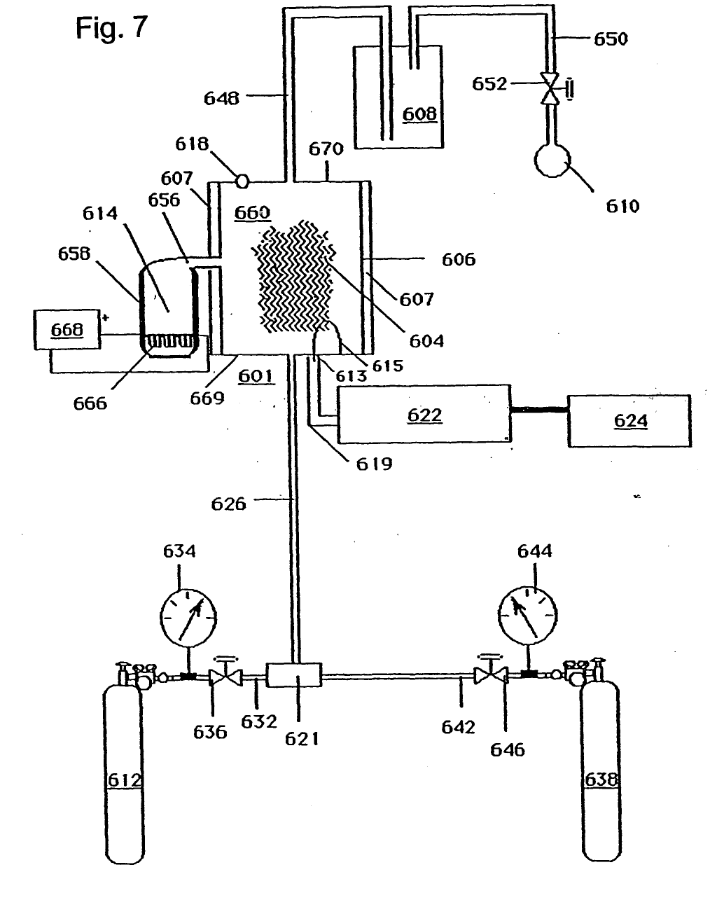

A microwave cell reactor of the present invention is shown in FIG. 7. The reactor system of FIG. 7 comprises a reaction vessel 601 having a chamber 660 capable of containing a vacuum or pressures greater than atmospheric. A source of hydrogen 638 delivers hydrogen to supply tube 642, and hydrogen flows to the chamber through hydrogen supply passage 626. The flow of hydrogen can be controlled by hydrogen flow controller 644 and valve 646. Plasma gas flows from the plasma gas supply 612 via passage 632. The flow of plasma gas can be controlled by plasma gas flow controller 634 and valve 636. A mixture of plasma gas and hydrogen can be supplied to the cell via passage 626. The mixture is controlled by hydrogen-plasma-gas mixer and mixture flow regulator 621. The plasma gas such as helium may be a source of catalyst such as He⁺ or He₂*, argon may be a source of catalyst such as Ar⁺, neon may serve as a source of catalyst such as Ne₂*, and neon-hydrogen mixture may serve as a source of catalyst such as Ne⁺/H⁺ and Ne⁺. The source of catalyst and hydrogen of the mixture flow into the plasma and become catalyst and atomic hydrogen in the chamber 660.

The plasma may be powered by a microwave generator 624 wherein the microwaves are tuned by a tunable microwave cavity 622, carried by waveguide 619, and can be delivered to the chamber 660 though an RF transparent window 613 or antenna 615. Sources of microwaves known in the art are traveling wave tubes, klystrons, magnetrons, cyclotron resonance masers, gyrotrons, and free electron lasers. The waveguide or antenna may be inside or outside of the cell. In the latter case, the microwaves may penetrate the cell from the source through a window of the cell 613. The microwave window may comprise Alumina or quartz.

In another embodiment, the cell 601 is a microwave resonator cavity. In an embodiment, the cavity is at least one of the group of Evenson, Beenakker, McCarrol, and cylindrical cavity. In an embodiment, the cavity provides a strong electromagnetic field which may form a nonthermal plasma. Usually the nonthermal plasma temperature is in the range of 5,000 to 5,000,000° C. Multiple sources of microwave power may be used simultaneously. In another embodiment, a multi slotted antenna such as a planar antenna serves as the equivalent of multiple sources of microwaves such as dipole-antenna-equivalent sources. One such embodiment is given in Y. Yasaka, D. Nozaki, M. Ando, T. Yamamoto, N. Goto, N. Ishii, T. Morimoto, “Production of large-diameter plasma using multi-slotted planar antenna,” Plasma Sources Sci. Technol., Vol. 8, (1999), pp. 530-533 which is incorporated herein by reference in its entirety.

The cell may further comprise a magnet such a solenoidal magnet 607 to provide an axial magnetic field wherein the magnetic field may be used to provide magnetic confinement. The microwave frequency is preferably in the range of about 1 MHz to about 100 GHz, more preferably in the range about 50 MHz to about 10 GHz, most preferably in the range of about 75 MHz±50 MHz or about 2.4 GHz±1 GHz.

A vacuum pump 610 may be used to evacuate the chamber 660 through vacuum lines 648 and 650. The cell may be operated under flow conditions with the hydrogen and the catalyst supplied continuously from catalyst source 612 and hydrogen source 638.

Hydrino hydride compounds can be cryopumped onto the wall 606, or they can flow into hydrino hydride compound trap 608 through passage 648. Alternatively dihydrino molecules may be collected in trap 608. Trap 608 communicates with vacuum pump 610 through vacuum line 650 and valve 652. A flow to the trap 608 can be effected by a pressure gradient controlled by the vacuum pump 610, vacuum line 650, and vacuum valve 652. In an embodiment, the microwave cell reactor further comprise a selective valve 618 for removal of lower-energy hydrogen products such as dihydrino molecules.

In another embodiment of the microwave cell reactor shown in FIG. 7, the wall 606 has a catalyst supply passage 656 for passage of the gaseous catalyst 614 from a catalyst reservoir 658 to the plasma 604. The catalyst in the catalyst reservoir 658 can be heated by a catalyst reservoir heater 666 having a power supply 668 to provide the gaseous catalyst to the plasma 604. The catalyst vapor pressure can be controlled by controlling the temperature of the catalyst reservoir 658 by adjusting the heater 666 with its power supply 668.

In another embodiment of the microwave cell reactor, a chemically resistant open container such as a ceramic boat located inside the chamber 660 contains the catalyst. The reactor further comprises a heater that may maintain an elevated temperature. The cell can be operated at an elevated temperature such that the catalyst in the boat is sublimed, boiled, or volatilized into the gas phase. Alternatively, the catalyst in the catalyst boat can be heated with a boat heater having a power supply to provide the gaseous catalyst to the plasma. The catalyst vapor pressure can be controlled by controlling the temperature of the cell with a cell heater, or by controlling the temperature of the boat by adjusting the boat heater with an associated power supply.

The molecular and atomic hydrogen partial pressures in the chamber 660, as well as the catalyst partial pressure, is preferably maintained in the range of about 1 mtorr to about 100 atm. Preferably the pressure is in the range of about 100 mtorr to about 1 atm, more preferably the pressure is about 100 mtorr to about 20 torr.

An exemplary plasma gas for the microwave cell reactor is argon. Exemplary flow rates are about 0.1 standard liters per minute (slm) hydrogen and about 1 slm argon. An exemplary forward microwave input power is about 1000 W. The flow rate of the plasma gas or hydrogen-plasma gas mixture such as at least one gas selected for the group of hydrogen, argon, helium, argon-hydrogen mixture, helium-hydrogen mixture is preferably about 0.000001-1 standard liters per minute per cm³ of vessel volume and more preferably about 0.001-10 sccm per cm³ of vessel volume. In the case of an argon-hydrogen or helium-hydrogen mixture, preferably helium or argon is in the range of about 99 to about 1%, more preferably about 99 to about 95%. The power density of the source of plasma power is preferably in the range of about 0.01 W to about 100 W/cm³ vessel volume.

1.7. Capacitively and Inductively Coupled RF Plasma Gas Cell Hydride and Power Reactor

A capacitively or inductively coupled radio frequency plasma (RF) plasma cell reactor of the present invention is also shown in FIG. 7. The cell structures, systems, catalysts, and methods may be the same as those given for the microwave plasma cell reactor except that the microwave source may be replaced by a RF source 624 with an impedance matching network 622 that may drive at least one electrode and/or a coil. The RF plasma cell may further comprise two electrodes 669 and 670. The coaxial cable 619 may connect to the electrode 669 by coaxial center conductor 615. Alternatively, the coaxial center conductor 615 may connect to an external source coil which is wrapped around the cell 601 which may terminate without a connection to ground or it may connect to ground. The electrode 670 may be connected to ground in the case of the parallel plate or external coil embodiments. The parallel electrode cell may be according to the industry standard, the Gaseous Electronics Conference (GEC) Reference Cell or modification thereof by those skilled in the art as described in G A. Hebner, K E. Greenberg, “Optical diagnostics in the Gaseous electronics Conference Reference Cell, J. Res. Natl. Inst. Stand. Technol., Vol. 100, (1995), pp. 373-383; V. S. Gathen, J. Ropcke, T. Gans, M. Kaning, C. Lukas, H. F. Dobele, “Diagnostic studies of species concentrations in a capacitively coupled RF plasma containing CH₄—H₂—Ar,” Plasma Sources Sci. Technol., Vol. 10, (2001), pp. 530-539; P. J. Hargis, et al., Rev. Sci. Instrum., Vol. 65, (1994), p. 140; Ph. Belenguer, L. C. Pitchford, J. C. Hubinois, “Electrical characteristics of a RF-GD-OES cell,” J. Anal. At. Spectrom., Vol. 16, (2001), pp. 1-3 which are herein incorporated by reference in their entirety. The cell which comprises an external source coil such as a 13.56 MHz external source coil microwave plasma source is as given in D. Barton, J. W. Bradley, D. A. Steele, and R. D. Short, “investigating radio frequency plasmas used for the modification of polymer surfaces,” J. Phys. Chem. B, Vol. 103, (1999), pp. 4423-4430; D. T. Clark, A. J. Dilks, J. Polym. Sci. Polym. Chem. Ed., Vol. 15, (1977), p. 2321; B. D. Beake, J. S. G. Ling, G. J. Leggett, J. Mater. Chem., Vol. 8, (1998), p. 1735; R. M. France, R. D. Short, Faraday Trans. Vol. 93, No. 3, (1997), p. 3173, and R. M. France, R. D. Short, Langmuir, Vol. 14, No. 17, (1998), p. 4827 which are herein incorporated by reference in their entirety. At least one wall of the cell 601 wrapped with the external coil is at least partially transparent to the RF excitation. The RF frequency is preferably in the range of about 100 Hz to about 100 GHz, more preferably in the range about 1 kHz to about 100 MHz, most preferably in the range of about 13.56 MHz±50 MHz or about 2.4 GHz±1 GHz.

In another embodiment, an inductively coupled plasma source is a toroidal plasma system such as the Astron system of Astex Corporation described in U.S. Pat. No. 6,150,628 which is herein incorporated by reference in its entirety. The toroidal plasma system may comprise a primary of a transformer circuit. The primary may be driven by a radio frequency power supply. The plasma may be a closed loop which acts at as a secondary of the transformer circuit. The RF frequency is preferably in the range of about 100 Hz to about 100 GHz, more preferably in the range about 1 kHz to about 100 MHz, most preferably in the range of about 13.56 MHz±50 MHz or about 2.4 GHz±1 GHz.

2. Intermittent or Pulsed Input Power

The present invention comprises a power source to at least partially maintain the plasma in the cell. The power to maintain a plasma may be intermittent or pulsed. Pulsing may be used to reduce the input power, and it may also provide a time period wherein the field is set to a desired strength by an offset DC, audio, RF, or microwave voltage or electric and magnetic fields which may be below those required to maintain a discharge. One application of controlling the field during the low-field or nondischarge period is to optimize the energy match between the catalyst and the atomic hydrogen. The pulse frequency and duty cycle may also be adjusted. An application of controlling the pulse frequency and duty cycle is to optimize the power balance. In an embodiment, this is achieved by optimizing the reaction rate versus the input power. The amount of catalyst and atomic hydrogen generated by the discharge decay during the low-field or nondischarge period. The reaction rate may be controlled by controlling the amount of catalyst generated by the discharge such as Ar⁺ and the amount of atomic hydrogen wherein the concentration is dependent on the pulse frequency, duty cycle, and the rate of decay. In an embodiment, the pulse frequency is of about 0.1 Hz to about 100 MHz. In another embodiment, the pulse frequency is faster than the time for substantial atomic hydrogen recombination to molecular hydrogen. Based on anomalous plasma afterglow duration studies [R. Mills, T. Onuma, and Y. Lu, “Formation of a Hydrogen Plasma from an Incandescently Heated Hydrogen-Catalyst Gas Mixture with an Anomalous Afterglow Duration”, Int. J. Hydrogen Energy, in press; R. Mills, “Temporal Behavior of Light-Emission in the Visible Spectral Range from a Ti—K2CO3-H-Cell”, Int. J. Hydrogen Energy, Vol. 26, No. 4, (2001), pp. 327-332], preferably the frequency is within the range of about 1 to about 1000 Hz. In an embodiment, the duty cycle is about 0.001% to about 95%. Preferably, the duty cycle is about 0.1% to about 50%.

The frequency of alternating power may be within the range of about 0.001 Hz to 100 GHz. More preferably the frequency is within the range of about 60 Hz to 10 GHz. Most preferably, the frequency is within the range of about 10 MHz to 10 GHz. The system may comprises two electrodes wherein one or more electrodes are in direct contact with the plasma; otherwise, the electrodes may be separated from the plasma by a dielectric barrier. The peak voltage may be within the range of about 1 V to 10 MV. More preferably, the peak voltage is within the range of about 10 V to 100 kV. Most preferably, the voltage is within the range of about 100 V to 500 V. Alternatively, the system comprises at least one antenna to deliver power to the plasma.

In an embodiment of the plasma cell, the catalyst comprises at least one selected from the group of He⁺, Ne⁺, and Ar⁺ wherein the ionized catalyst ion is generated from the corresponding atom by a plasma created by methods such as a glow, inductively or capacitively coupled RF, or microwave discharge. Preferably the hydrogen pressure of the plasma cell is within the range of 1 mTorr to 10,000 Torr, more preferably the hydrogen pressure of the hydrogen microwave plasma is within the range of 10 mTorr to 100 Torr; most preferably, the hydrogen pressure of the hydrogen microwave plasma is within the range of 10 mTorr to 10 Torr.

A microwave plasma cell of the present invention for the catalysis of atomic hydrogen to form increased-binding-energy-hydrogen species and increased-binding-energy-hydrogen compounds comprises a vessel having a chamber capable of containing a vacuum or pressures greater than atmospheric, a source of atomic hydrogen, a source of microwave power to form a plasma, and a catalyst capable of providing a net enthalpy of reaction of m/2·27.2±0.5 eV where m is an integer, preferably m is an integer less than 400. Sources of microwaves known in the art are traveling wave tubes, klystrons, magnetrons, cyclotron resonance masers, gyrotrons, and free electron lasers. The power may be amplified with an amplifier. The power may be delivered by at least one of a waveguide, coaxial cable, and an antenna. A preferred embodiment of pulsed microwaves comprises a magnetron with a pulsed high voltage to the magnetron or a pulsed magnetron current that may be supplied by a pulse of electrons from an electron source such as an electron gun.

The frequency of the alternating power may be within the range of about 100 MHz to 100 GHz. More preferably, the frequency is within the range of about 100 MHz to 10 GHz. Most preferably, the frequency is within the range of about 1 GHz to 10 GHz or about 2.4 GHz±1 GHz. In an embodiment, the pulse frequency is of about 0.1 Hz to about 100 MHz, preferably the frequency is within the range of about 10 to about 10,000 Hz, most preferably the frequency is within the range of about 100 to about 1000 Hz. In an embodiment, the duty cycle is about 0.001% to about 95%. Preferably, the duty cycle is about 0.1% to about 10%. The peak power density of the pulses into the plasma may be within the range of about 1 W/cm³ to 1 GW/cm³. More preferably, the peak power density is within the range of about 10 W/cm³ to 10 MW/cm³. Most preferably, the peak power density is within the range of about 100 W/cm³ to 10 kW/cm³. The average power density into the plasma may be within the range of about 0.001 W/cm³ to 1 kW/cm³. More preferably, the average power density is within the range of about 0.1 W/cm³ to 100 W/cm³. Most preferably, the average power density is within the range of about 1 W/cm³ to 10 W/cm³.

A capacitively and/or inductively coupled radio frequency (RF) plasma cell of the present invention for the catalysis of atomic hydrogen to form increased-binding-energy-hydrogen species and increased-binding-energy-hydrogen compounds comprises a vessel having a chamber capable of containing a vacuum or pressures greater than atmospheric, a source of atomic hydrogen, a source of RF power to form a plasma, and a catalyst capable of providing a net enthalpy of reaction of m/2·27.2±0.5 eV where m is an integer, preferably m is an integer less than 400. The cell may further comprise at least two electrodes and an RF generator wherein the source of RF power may comprise the electrodes driven by the RF generator. Alternatively, the cell may further comprise a source coil which may be external to a cell wall which permits RF power to couple to the plasma formed in the cell, a conducting cell wall which may be grounded and a RF generator which drives the coil which may inductively and/or capacitively couple RF power to the cell plasma. The RE frequency is preferably within the range of about 100 Hz to about 100 MHz, more preferably within the range about 1 kHz to about 50 MHz, most preferably within the range of about 13.56 MHz±50 MHz. In an embodiment, the pulse frequency is of about 0.1 Hz to about 100 MHz, preferably the frequency is within the range of about 10 Hz to about 10 MHz, most preferably the frequency is within the range of about 100 Hz to about 1 MHz. In an embodiment, the duty cycle is about 0.001% to about 95%. Preferably, the duty cycle is about 0.1% to about 10%. The peak power density of the pulses into the plasma may be within the range of about 1 W/cm³ to 1 GW/cm³. More preferably, the peak power density is within the range of about 10 W/cm³ to 10 MW/cm³. Most preferably, the peak power density is within the range of about 100 W/cm³ to 10 kW/cm³. The average power density into the plasma may be within the range of about 0.001 W/cm³ to 1 kW/cm³. More preferably, the average power density is within the range of about 0.1 W/cm³ to 100 W/cm³. Most preferably, the average power density is within the range of about 1 W/cm³ to 10 W/cm³.

In another embodiment, an inductively coupled plasma source is a toroidal plasma system such as the Astron system of Astex Corporation described in U.S. Pat. No. 6,150,628 which is herein incorporated by reference in its entirety. The toroidal plasma system may comprise a primary of a transformer circuit. The primary may be driven by a radio frequency power supply. The plasma may be a closed loop which acts at as a secondary of the transformer circuit. The RF frequency is preferably within the range of about 100 Hz to about 100 GHz, more preferably within the range about 1 kHz to about 100 MHz, most preferably within the range of about 13.56 MHz±50 MHz or about 2.4 GHz±1 GHz. In an embodiment, the pulse frequency is of about 0.1 Hz to about 100 MHz, preferably the frequency is within the range of about 10 Hz to about 10 MHz, most preferably the frequency is within the range of about 100 Hz to about 1 MHz. In an embodiment, the duty cycle is about 0.001% to about 95%. Preferably, the duty cycle is about 0.1% to about 10%. The peak power density of the pulses into the plasma may be within the range of about 1 W/cm³ to 1 GW/cm³. More preferably, the peak power density is within the range of about 10 W/cm³ to 10 MW/cm³. Most preferably, the peak power density is within the range of about 100 W/cm³ to 10 kW/cm³. The average power density into the plasma may be within the range of about 0.001 W/cm³ to 1 kW/cm³. More preferably, the average power density is within the range of about 0.1 W/cm³ to 100 W/cm³. Most preferably, the average power density is within the range of about 1 W/cm³ to 10 W/cm³.

In the case of the discharge cell, the discharge voltage may be within the range of about 1000 to about 50,000 volts. The current may be within the range of about 1 μA to about 1 A, preferably about 1 mA. The discharge current may be intermittent or pulsed. Pulsing may be used to reduce the input power, and it may also provide a time period wherein the field is set to a desired strength by an offset voltage which may be below the discharge voltage. One application of controlling the field during the nondischarge period is to optimize the energy match between the catalyst and the atomic hydrogen. In an embodiment, the offset voltage is between, about 0.5 to about 500 V. In another embodiment, the offset voltage is set to provide a field of about 0.1 V/cm to about 50 V/cm. Preferably, the offset voltage is set to provide a field between about 1 V/cm to about 10 V/cm. The peak voltage may be within the range of about 1 V to 10 MV. More preferably, the peak voltage is within the range of about 10 V to 100 kV. Most preferably, the voltage is within the range of about 100 V to 500 V. The pulse frequency and duty cycle may also be adjusted. An application of controlling the pulse frequency and duty cycle is to optimize the power balance. In an embodiment, this is achieved by optimizing the reaction rate versus the input power. The amount of catalyst and atomic hydrogen generated by the discharge decay during the nondischarge period. The reaction rate may be controlled by controlling the amount of catalyst generated by the discharge such as Ar⁺ and the amount of atomic hydrogen wherein the concentration is dependent on the pulse frequency, duty cycle, and the rate of decay. In an embodiment, the pulse frequency is of about 0.1 Hz to about 100 MHz. In another embodiment, the pulse frequency is faster than the time for substantial atomic hydrogen recombination to molecular hydrogen. Based on anomalous plasma afterglow duration studies [R. Mills, T. Onuma, and Y. Lu, “Formation of a Hydrogen Plasma from an Incandescently Heated Hydrogen-Catalyst Gas Mixture with an Anomalous Afterglow Duration”, Int. J. Hydrogen Energy, in press; R. Mills, “Temporal Behavior of Light-Emission in the Visible Spectral Range from a Ti—K2CO3-H-Cell”, hit. J. Hydrogen Energy, Vol. 26, No. 4, (2001), pp. 327-332], preferably the frequency is within the range of about 1 to about 200 Hz. In an embodiment, the duty cycle is about 0.1% to about 95%. Preferably, the duty cycle is about 1% to about 50%.

In another embodiment, the power may be applied as an alternating current (AC). The frequency may be within the range of about 0.001 Hz to 1 GHz. More preferably the frequency is within the range of about 60 Hz to 100 MHz. Most preferably, the frequency is within the range of about 10 to 1100 MHz. The system may comprises two electrodes wherein one or more electrodes are in direct contact with the plasma; otherwise, the electrodes may be separated from the plasma by a dielectric barrier. The peak voltage may be within the range of about 1 V to 10 MV. More preferably, the peak voltage is within the range of about 10 V to 100 kV. Most preferably, the voltage is within the range of about 100 V to 500 V.

In the case of a barrier electrode plasma cell, the frequency is preferably within the range of about 100 Hz to about 10 GHz, more preferably, about 1 kHz to about 1 MHz, most preferably about 5-10 kHz. The voltage is preferably within the range of about 100 V to about 1 MV, more preferably about 1 kV to about 100 kV, and most preferably about 5 to about 10 kV.

In the case of the plasma electrolysis cell, the discharge voltage may be within the range of about 1000 to about 50,000 volts. The current into the electrolyte may be within the range of about 1 μA/cm³ to about 1 A/cm³, preferably about 1 mA/Cm³. In an embodiment, the offset voltage is below that which causes electrolysis such as within the range of about 0.001 to about 1.4 V. The peak voltage may be within the range of about 1 V to 10 MV. More preferably, the peak voltage is within the range of about 2 V to 100 kV. Most preferably, the voltage is within the range of about 2 V to 1 kV. In an embodiment, the pulse frequency is within the range of about 0.1 Hz to about 100 MHz. Preferably the frequency is within the range of about 1 to about 200 Hz. In an embodiment, the duty cycle is about 0.1% to about 95%. Preferably, the duty cycle is about 1% to about 50%.

In the case of the filament cell, the field from the filament may alternate from a higher to lower value during pulsing. The peak field may be within the range of about 0.1 V/cm to 1000 V/cm. Preferably, the peak field may be within the range of about 1 V/cm to 10 V/cm. The off-peak field may be within the range of about 0.1 V to 100 V/cm. Preferably, the off-peak field may be within the range of about 0.1 V to 1 V/cm. In an embodiment, the pulse frequency is within the range of about 0.1 Hz to about 100 MHz. Preferably the frequency is within the range of about 1 to about 200 Hz. In an embodiment, the duty cycle is about 0.1% to about 95%. Preferably, the duty cycle is about 1% to about 50%.

An exemplary plasma gas for the plasma reactor to generate power and novel hydrogen species and compositions of matter comprising new forms of hydrogen via the catalysis of atomic hydrogen is at least one of helium, neon, and argon corresponding to a source of the catalysts He⁺, Ne⁺, and Ar⁺, respectively. In embodiments, hydrogen is flowed into the plasma cell separately or as a mixture with other plasma gases such as those that serve as sources of catalysts. The flow rate of the catalyst gas or hydrogen-catalyst gas mixture such as at least one gas selected for the group of hydrogen, argon, helium, argon-hydrogen mixture, helium-hydrogen mixture is preferably about 0.00000001-1 standard liters per minute per cm³ of vessel volume and more preferably about 0.001-10 sccm per cm³ of vessel volume. In the case of a helium-hydrogen, a neon-hydrogen, and an argon-hydrogen mixture, the helium, neon, or argon is in the range of about 99.99 to about 0.01%, preferably in the range of about 99 to about 1%, and more preferably about 99 to about 95%. In an embodiment, the remaining gas is hydrogen.

In any of the above reactors, an aspirator, atomizer, or nebulizer can be used to form an aerosol of the source of catalyst. If desired, the aspirator, atomizer, or nebulizer can be used to inject the source of catalyst or catalyst directly into the plasma.

If molybdenum is used as a cell material, the temperature of the operating cell is preferably maintained in the range of 0-1800° C. If tungsten is used as a cell material, the temperature of the operating cell is preferably maintained in the range of 0-3000° C. If stainless steel is used as a cell material, the temperature of the operating cell is preferably maintained in the range of 0-1200° C.

1. A plasma reactor to generate power and novel hydrogen species and compositions of matter comprising new forms of hydrogen via the catalysis of atomic hydrogen and to generate a plasma and a source of light via the catalysis of atomic hydrogen, the reactor comprising
a plasma forming energy cell for the catalysis of atomic hydrogen to form lower-energy hydrogen species and compositions of matter comprising lower-energy hydrogen,
a source of catalyst for catalyzing the reaction of atomic hydrogen to form the lower-energy hydrogen and release energy,
a source of atomic hydrogen, and
a source of intermittent or pulsed power to at least partially maintain the plasma.

2. The reactor of claim 1 wherein the cell comprises at least one of the group of a microwave cell, plasma torch cell, radio frequency (RF) cell, glow discharge cell, barrier electrode cell, plasma electrolysis cell, a pressurized gas cell, filament cell or rt-plasma cell, and a combination of at least one of a glow discharge cell, a microwave cell, and an RF plasma cell.

3. The reactor of claim 1 wherein the intermittent or pulsed power source reduces the input power.

4. The reactor of claim 1 wherein the intermittent or pulsed power source provides a time period wherein the field is set to a desired strength by an offset DC, audio, RF, or microwave voltage or electric and magnetic fields.

5. The reactor of claim 4 wherein the field is set to a desired strength during a time period by an offset DC, audio, RF, or microwave voltage or electric and magnetic fields that is below that required to maintain a discharge.

6. The reactor of claim 4 wherein the desired field strength during a low-field or nondischarge period optimizes the energy match between the catalyst and the atomic hydrogen.

7. The reactor of claim 1 wherein the intermittent or pulsed power source further comprises a means to adjust the pulse frequency and duty cycle to optimize the power balance.

8. The reactor of claim 7 wherein the pulse frequency and duty cycle is adjusted to optimize the power balance by optimizing the reaction rate versus the input power.

9. The reactor of claim 9 wherein the pulse frequency and duty cycle is adjusted to optimize the power balance by optimizing the reaction rate versus the input power by controlling the amount of catalyst and atomic hydrogen generated by the discharge decay during the low-field or nondischarge period wherein the concentrations are dependent on the pulse frequency, duty cycle, and the rate of plasma decay.

10. The reactor of claim 107 wherein the catalyst is selected from the group of He⁺, Ne⁺, and Ar⁺.

11. The reactor of claim 1 wherein the intermittent or pulsed frequency is of about 0.1 Hz to about 100 MHz.

12. The reactor of claim 1 wherein the intermittent or pulsed frequency is faster than the time for substantial atomic hydrogen recombination to molecular hydrogen.

13. The reactor of claim 1 wherein the intermittent or pulsed frequency is within the range of about 1 to about 1000 Hz and the duty cycle is about 0.001% to about 95%.

14. The reactor of claim 1 wherein the intermittent or pulsed duty cycle is about 0.1% to about 50%.

15. The reactor of claim 1 wherein the power is alternating and the frequency of the alternating power may be within the range of about 0.001 Hz to 100 GHz.

16. The reactor of claim 1 wherein the intermittent or pulsed frequency is within the range of about 60 Hz to 10 GHz.

17. The reactor of claim 1 wherein the intermittent or pulsed frequency is within the range of about 10 MHz to 10 GHz.

18. The reactor of claim 1 that comprises two electrodes wherein one or more electrodes are at least one of in direct contact with the plasma, and separated from the plasma by a dielectric barrier.

19. The reactor of claim 18 wherein the peak voltage is within the range of at least one of about 1 V to 10 MV, about 10 V to 100 kV, and about 100 V to 500 V.

20. The reactor of claim 1 that further comprises at least one antenna to deliver power to the plasma.

21. The reactor of claim 1 wherein the catalyst comprises at least one selected from the group of He⁺, Ne⁺, and Ar⁺ wherein the ionized catalyst ion is generated from the corresponding atom by a plasma created by methods such as a glow, inductively or capacitively coupled RF, or microwave discharge.

22. The reactor of claim 1 wherein hydrogen pressure of the plasma cell is at least one of within the range of about 1 mTorr to 10,000 Torr, about 10 mTorr to 100 Torr, and about 10 mTorr to 10 Torr.

23. The reactor of claim 1 comprising a microwave plasma cell for the catalysis of atomic hydrogen to form increased-binding-energy-hydrogen species and increased-binding-energy-hydrogen compounds comprising a vessel having a chamber capable of containing a vacuum or pressures greater than atmospheric, a source of atomic hydrogen, a source of pulsed or intermittent microwave power to form a plasma, and a catalyst capable of providing a net enthalpy of reaction of m/2·27.2±0.5 eV where m is an integer, preferably m is an integer less than 400.

24. The reactor of claim 1 wherein the source of pulsed or intermittent microwave power comprises at least one of the group of traveling wave tubes, klystrons, magnetrons, cyclotron resonance masers, gyrotrons, and free electron lasers.

25. The reactor of claim 1 wherein the source of pulsed or intermittent microwave power comprises an amplifier to amplify the microwave power.

26. The reactor of claim 1 wherein the source of pulsed or intermittent microwave power is delivered by at least one of a waveguide, coaxial cable, and an antenna.

27. The reactor of claim 1 wherein the source of pulsed or intermittent microwave power comprises at least one of a magnetron with a pulsed high voltage to the magnetron and a pulsed magnetron current.

28. The reactor of claim 27 wherein the pulsed magnetron current is supplied by a pulse of electrons from an electron source.

29. The reactor of claim 28 wherein the source of pulses of electrons from an electron source is an electron gun.

30. The reactor of claim 1 wherein the source of pulsed or intermittent microwave power comprises a frequency of the power may be within the range of at least one of about 100 MHz to 100 GHz, about 100 MHz to 10 GHz, about 1 GHz to 10 GHz, and about 2.4 GHz±1 GHz.

31. The reactor of claim 1 wherein the pulse frequency is at least one of the range of about 0.1 Hz to about 100 MHz, about 10 to about 10,000 Hz, and about 100 to about 1000 Hz.

32. The reactor of claim 1 wherein the duty cycle is at least one of the range of about 0.001% to about 95%, and about 0.1% to about 10%.

33. The reactor of claim 1 wherein the peak power density of the pulses into the plasma is at least one of the range of about 1 W/cm³ to 1 GW/cm³, about 10 W/cm³ to 10 MW/cm³, and about 100 W/cm³ to 10 kW/cm³.

34. The reactor of claim 1 wherein the average power density of the pulses into the plasma is at least one of the range of about 0.001 W/cm³ to 1 kW/cm³, about 0.1 W/cm³ to 100 W/cm³, and about 1 W/cm³ to 10 W/cm³.

35. The reactor of claim 1 comprising at least one of a capacitively and inductively coupled radio frequency (RF) plasma cell for the catalysis of atomic hydrogen to form increased-binding-energy-hydrogen species and increased-binding-energy-hydrogen compounds comprising a vessel having a chamber capable of containing a vacuum or pressures greater than atmospheric, a source of atomic hydrogen, a source of pulsed or intermittent RF power to form a plasma, and a catalyst capable of providing a net enthalpy of reaction of m/2·27.2±0.5 eV where m is an integer, preferably m is an integer less than 400.

36. The reactor of claim 35 comprising at least two electrodes and a pulsed or intermittent RF generator wherein the source of RF power comprises the electrodes driven by the RF generator.

37. The reactor of claim 35 comprising a source coil that is either internal or external to a cell wall which permits RF power to couple to the plasma formed in the cell, a conducting cell wall is one of grounded and floating, and n RF generator which drives the coil by at least one of inductively and capacitively coupling RF power to the cell plasma.

38. The reactor of claim 35 wherein the RF frequency is at least one of the range of about 100 Hz to about 100 MHz, about 1 kHz to about 50 MHz, and about 13.56 MHz±50 MHz.

39. The reactor of claim 35 wherein the pulse frequency is at least one of the range of about 0.1 Hz to about 100 MHz, about 10 Hz to about 10 MHz, and about 100 Hz to about 1 MHz.

40. The reactor of claim 35 wherein the duty cycle is at least one of the range of about 0.001% to about 95%, and about 0.1% to about 10%.

41. The reactor of claim 35 wherein the peak power density of the pulses into the plasma is at least one of the range of about 1 W/cm³ to 1 GW/cm³, about 10 W/cm³ to 10 MW/cm³, and about 100 W/cm³ to 10 kW/cm³.

42. The reactor of claim 35 wherein the average power density of the pulses into the plasma is at least one of the range of about 0.001 W/cm³ to 1 kW/cm³, about 0.1 W/cm³ to 100 W/cm³, and about 1 W/cm³ to 10 W/cm³.

43. The reactor of claim 1 comprising an inductively coupled plasma source comprising a toroidal plasma system such as the Astron system of Astex Corporation described in U.S. Pat. No. 6,150,628.

44. The reactor of claim 43, comprising a toroidal plasma system comprising a primary of a transformer circuit.

45. The reactor of claim 44 further comprising a radio frequency power supply that drives the primary of the transformer circuit.

46. The reactor of claim 44 wherein the plasma is a closed loop which acts at as a secondary of the transformer circuit.

47. The reactor of claim 44 wherein the RF frequency is at least one of within the range of about 100 Hz to about 100 GHz, about 100 MHz, about 13.56 MHz±50 MHz, and about 2.4 GHz±1 GHz.

48. The reactor of claim 44 wherein the pulse frequency is at least one of within the range of about 0.1 Hz to about 100 MHz, about 10 Hz to about 10 MHz, and about 100 Hz to about 1 MHz.

49. The reactor of claim 44 wherein the duty cycle is at least one of within the range of about 0.001% to about 95%, and about 0.1% to about 10%.

50. The reactor of claim 44 wherein the peak power density of the pulses into the plasma is at least one of within the range of about 1 W/cm³ to 1 GW/cm³, about 10 W/cm³ to 10 MW/cm³, and about 100 W/cm³ to 10 kW/cm³.

51. The reactor of claim 44 wherein the average power density of the pulses into the plasma is at least one of within the range of about 0.001 W/cm³ to 1 kW/cm³, about 0.1 W/cm³ to 100 W/cm³, and about 1 W/cm³ to 10 W/cm³.

52. The reactor of claim 1 comprising a discharge cell wherein the discharge voltage is within the range of about 1000 to about 50,000 volts and the intermittent or pulsed discharge current is within the range of about 1 μA to about 1 A.

53. The reactor of claim 52 having an offset voltage during the nonpeak-power phase of the intermittent or pulsed power that is within the range of about 0.5 to about 500 V.

54. The reactor of claim 53 wherein the offset voltage is set to provide a field that is at least one of within the range of about 0.1 V/cm to about 50 V/cm, and about 1 V/cm to about 10 V/cm.

55. The reactor of claim 52 having a peak voltage that is at least one of within the range of about 1 V to 10 MV, about 10 V to 100 kV, and about 100 V to 500 V.

56. The reactor of claim 52 wherein the desired field strength during a low-field or nondischarge period optimizes the energy match between the catalyst and the atomic hydrogen.

57. The reactor of claim 52 wherein the intermittent or pulsed power source further comprises a means to adjust the pulse frequency and duty cycle to optimize the power balance.

58. The reactor of claim 57 wherein the pulse frequency and duty cycle is adjusted to optimize the power balance by optimizing the reaction rate versus the input power.

59. The reactor of claim 58 wherein the pulse frequency and duty cycle is adjusted to optimize the power balance by optimizing the reaction rate versus the input power by controlling the amount of catalyst and atomic hydrogen generated by the discharge decay during the low-field or nondischarge period wherein the concentrations are dependent on the pulse frequency, duty cycle, and the rate of plasma decay.

60. The reactor of claim 59 wherein the catalyst is selected from the group of He⁺, Ne⁺, and Ar⁺.

61. The reactor of claim 52 wherein the intermittent or pulsed frequency is of about 0.1 Hz to about 100 MHz.

62. The reactor of claim 52 wherein the intermittent or pulsed frequency is faster than the time for substantial atomic hydrogen recombination to molecular hydrogen.

63. The reactor of claim 52 wherein the intermittent or pulsed frequency is within the range of about 1 to about 200 Hz, the duty cycle is within the range of about 0.1% to about 95%.

64. The reactor of claim 52 wherein the intermittent or pulsed duty cycle is about 1% to about 50%.

65. The reactor of claim 52 wherein the power may be applied as an alternating current (AC).

66. The reactor of claim 65 wherein the frequency is at least one of within the range of about 0.001 Hz to 1 GHz, about 60 Hz to 100 MHz, and about 10 to 100 MHz.

67. The reactor of claim 66 that comprises two electrodes wherein one or more electrodes are at least one of in direct contact with the plasma, and separated from the plasma by a dielectric barrier.

68. The reactor of claim 67 wherein the peak voltage is within the range of about at least one of about 1 V to 10 MV, about 10 V to 100 kV, and about 100 V to 500 V.

69. The reactor of claim 67 wherein the frequency is at least one of within the range of about 100 Hz to about 10 GHz, about 1 kHz to about 1 MHz, and about 5-10 kHz.

70. The reactor of claim 67 wherein the voltage is at least one of within the range of about 100 V to about 1 MV, about 1 kV to about 100 kV, and about 5 to about 10 kV.

71. The reactor of claim 1 comprising a pulsed plasma electrolysis cell wherein the discharge voltage is within the range of about 1000 to about 50,000 volts, and the discharge current into the electrolyte is within the range of about 1 μA/cm³ to about 1 A/cm³.

72. The reactor of claim 71 having an offset voltage that is below that which causes electrolysis.

73. The reactor of claim 72 wherein the offset voltage is within the range of about 0.001 to about 1.4 V.

74. The reactor of claim 71 wherein the peak voltage is at least one of within the range of about 1 V to 10 MV, about 2 V to 100 kV, and about 2 V to 1 kV.

75. The reactor of claim 71 wherein the pulse frequency is at least one of within the range of about 0.1 Hz to about 100 MHz, and about 1 to about 200 Hz.

76. The reactor of claim 71 wherein the duty cycle is at least one of within the range of about 0.1% to about 95%, and about 1% to about 50%.

77. The reactor of claim 1 comprising a filament cell wherein the field from the filament alternates from a higher to lower value during pulsing.

78. The reactor of claim 77 wherein the peak field is at least one of within the range of about 0.1 V/cm to 1000 V/cm, and about 1 V/cm to 10 V/cm.

79. The reactor of claim 77 wherein the off-peak field is at least one of within the range of about 0.1 V to 100 V/cm, and about 0.1 V to 1 V/cm.

80. The reactor of claim 77 wherein the pulse frequency is at least one of within the range of about 0.1 Hz to about 100 MHz, and about 1 to about 200 Hz.

81. The reactor of claim 77 wherein the duty cycle is at least one of within the range of about 0.1% to about 95%, and about 1% to about 50%.

82. The reactor of claim 1, wherein a compound produced comprising:
(a) at least one neutral, positive, or negative increased binding energy hydrogen species having a binding energy
(i) greater than the binding energy of the corresponding ordinary hydrogen species, or
(ii) greater than the binding energy of any hydrogen species for which the corresponding ordinary hydrogen species is unstable or is not observed because the ordinary hydrogen species' binding energy is less than thermal energies at ambient conditions, or is negative; and
(b) at least one other element.

83. A reactor of claim 82 characterized in that the increased binding energy hydrogen species is selected from the group consisting of Hₙ, Hₙ⁻, and Hₙ⁺ where n is a positive integer, with the proviso that n is greater than 1 when H has a positive charge.

84. A reactor of claim 82 characterized in that the increased binding energy hydrogen species is selected from the group consisting of (a) hydride ion having a binding energy that is greater than the binding of ordinary hydride ion (about 0.8 eV) for p=2 up to 23 in which the binding energy is represented by
$$Binding Energy = \frac{{ℏ}^{2} \sqrt{s ( s + 1 )}}{8 {μ}_{e} {{a}_{0}^{2} [ \frac{1 + \sqrt{s ( s + 1 )}}{p} ]}^{2}} - \frac{{πμ}_{0} {e}^{2} {ℏ}^{2}}{{m}_{e}^{2}} ( \frac{1}{{a}_{H}^{3}} + \frac{{2}^{2}}{{{a}_{0}^{3} [ \frac{1 + \sqrt{s ( s + 1 )}}{p} ]}^{3}} )$$
where p is an integer greater than one, s=½, π is pi, \overline{h} is Planck's constant bar, μₒ is the permeability of vacuum, mₑ is the mass of the electron, μₑ is the reduced electron mass given by
$${μ}_{e} = \frac{{m}_{e} {m}_{p}}{\frac{{m}_{e}}{\sqrt{\frac{3}{4}}} + {m}_{p}}$$
where mₚ is the mass of the proton, a_{H} is the radius of the hydrogen atom, aₒ is the Bohr radius, and e is the elementary charge; (b) hydrogen atom having a binding energy greater than about 13.6 eV; (c) hydrogen molecule having a first binding energy greater than about 15.3 eV; and (d) molecular hydrogen ion having a binding energy greater than about 16.3 eV.

85. A reactor of claim 84 characterized in that the increased binding energy hydrogen species is a hydride ion having a binding energy of about 3, 6.6, 11.2, 16.7, 22.8, 29.3, 36.1, 42.8, 49.4, 55.5, 61.0, 65.6, 69.2, 71.6, 72.4, 71.6, 68.8, 64.0, 56.8, 47.1, 34.7, 19.3, and 0.69 eV.

86. A reactor of claim 82 characterized in that the increased binding energy hydrogen species is a hydride ion having the binding energy:
$$Binding Energy = \frac{{ℏ}^{2} \sqrt{s ( s + 1 )}}{8 {μ}_{e} {{a}_{0}^{2} [ \frac{1 + \sqrt{s ( s + 1 )}}{p} ]}^{2}} - \frac{{πμ}_{0} {ⅇ}^{2} {ℏ}^{2}}{{m}_{e}^{2}} ( \frac{1}{{a}_{H}^{3}} + \frac{{2}^{2}}{{{a}_{0}^{3} [ \frac{1 + \sqrt{s ( s + 1 )}}{p} ]}^{3}} )$$
where p is an integer greater than one, s=½, π is pi, \overline{h} is Planck's constant bar, μₒ is the permeability of vacuum, mₑ is the mass of the electron, μₑ is the reduced electron mass given by
$${μ}_{e} = \frac{{m}_{e} {m}_{p}}{\frac{{m}_{e}}{\sqrt{\frac{3}{4}}} + {m}_{p}}$$
where mₚ is the mass of the proton, a_{H} is the radius of the hydrogen atom, aₒ is the Bohr radius, and e is the elementary charge.

87. A reactor of claim 82 characterized in that the increased binding energy hydrogen species is selected from the group consisting of
(a) a hydrogen atom having a binding energy of about
$$\frac{13.6 eV}{{( \frac{1}{p} )}^{2}}$$
where p is an integer,
(b) an increased binding energy hydride ion (H⁻) having a binding energy of about
$$Binding Energy = \frac{{ℏ}^{2} \sqrt{s ( s + 1 )}}{8 {μ}_{e} {{a}_{0}^{2} [ \frac{1 + \sqrt{s ( s + 1 )}}{p} ]}^{2}} - \frac{{πμ}_{0} {ⅇ}^{2} {ℏ}^{2}}{{m}_{e}^{2}} ( \frac{1}{{a}_{H}^{3}} + \frac{{2}^{2}}{{{a}_{0}^{3} [ \frac{1 + \sqrt{s ( s + 1 )}}{p} ]}^{3}} )$$
where p is an integer greater than one, s=½, π is pi, \overline{h} is Planck's constant bar, μₒ is the permeability of vacuum, mₑ is the mass of the electron, μₑ is the reduced electron mass given by
$${μ}_{e} = \frac{{m}_{e} {m}_{p}}{\frac{{m}_{e}}{\sqrt{\frac{3}{4}}} + {m}_{p}}$$
where mₚ is the mass of the proton, a_{H} is the radius of the hydrogen atom, aₒ is the Bohr radius, and e is the elementary charge;
(c) an increased binding energy hydrogen species H₄⁺ (1/p);
(d) an increased binding energy hydrogen species trihydrino molecular ion, H₃⁺ (1/p), having a binding energy of about
$$\frac{22.6}{{( \frac{1}{p} )}^{2}} eV$$
where p is an integer,
(e) an increased binding energy hydrogen molecule having a binding energy of about
$$\frac{15.3}{{( \frac{1}{p} )}^{2}} eV ;$$
and
(f) an increased binding energy hydrogen molecular ion with a binding energy of about
$$\frac{16.3}{{( \frac{1}{p} )}^{2}} eV .$$

88. The reactor of claim 1 wherein the catalyst comprises a chemical or physical process that provides a net enthalpy of m·27.2±0.5 eV where m is an integer or m/2·27.2±0.5 eV where m is an integer greater than one.

89. The reactor of claim 1 wherein the catalyst provides a net enthalpy of m·27.2±0.5 eV where m is an integer or m/2·27.2±0.5 eV where m is an integer greater than one corresponding to a resonant state energy level of the catalyst that is excited to provide the enthalpy.

90. The reactor of claim 89 wherein preferably m is an integer less than 400.

91. The reactor of claim 1 wherein a catalytic system is provided by the ionization of t electrons from a participating species such as an atom, an ion, a molecule, and an ionic or molecular compound to a continuum energy level such that the sum of the ionization energies of the t electrons is approximately m·27.2±0.5 eV where m is an integer or m/2·27.2±0.5 eV where m is an integer greater than one and t is an integer.

92. The reactor of claim 91 wherein preferably m is an integer less than 400.

93. The reactor of claim 1 wherein the catalyst is provided by the transfer of t electrons between participating ions; the transfer of t electrons from one ion to another ion provides a net enthalpy of reaction whereby the sum of the ionization energy of the electron donating ion minus the ionization energy of the electron accepting ion equals approximately m·27.2±0.5 eV where m is an integer or m/2·27.2±0.5 eV where m is an integer greater than one and t is an integer.

94. The reactor of claim 93 wherein preferably m is an integer less than 400.

95. The reactor of claim 1 wherein the catalyst comprises He⁺ which absorbs 40.8 eV during the transition from the n=1 energy level to the n=2 energy level which corresponds to 3/2·27.2 eV (m=3) that serves as a catalyst for the transition of atomic hydrogen from the n=1 (p=1) state to the n=½ (p=2) state.

96. The reactor of claim 1 wherein the catalyst comprises Ar²⁺ which absorbs 40.8 eV and is ionized to Ar³⁺ which corresponds to 3/2·27.2 eV (m=3) during the transition of atomic hydrogen from the n=1 (p=1) energy level to the n=½ (p=2) energy level.

97. The reactor of claim 1 wherein the catalyst is selected from the group of Li, Be, K, Ca, Ti, V, Cr, Mn, Fe, Co, Ni, Cu, Zn, As, Se, Kr, Rb, Sr, Nb, Mo, Pd, Sn, Te, Cs, Ce, Pr, Sm, Gd, Dy, Pb, Pt, 2K⁺, He⁺, Na⁺, Rb⁺, Sr⁺, Fe³⁺, Mo²⁺, Mo⁴⁺, and In³⁺.

98. The reactor of claim 1, wherein the catalyst of atomic hydrogen is capable of providing a net enthalpy of m·27.2±0.5 eV where m is an integer or m/2·27.2±0.5 eV where m is an integer greater than one and capable of forming a hydrogen atom having a binding energy of about
$$\frac{13.6 eV}{{( \frac{1}{p} )}^{2}}$$
where p is an integer wherein the net enthalpy is provided by the breaking of a molecular bond of the catalyst and the ionization of t electrons from an atom of the broken molecule each to a continuum energy level such that the sum of the bond energy and the ionization energies of the t electrons is approximately m·27.2±0.5 eV where m is an integer or m/2·27.2±0.5 eV where m is an integer greater than one.

99. The reactor of claim 1 wherein the catalyst comprises at least one of C₂, N₂, O₂, CO₂, NO₂, and NO₃.

100. The reactor of claim 1 wherein the catalyst comprises a molecule in combination with an ion or atom catalyst.

101. The reactor of claim 100 wherein the catalyst comprises at least one molecule selected from the group of C₂, N₂, O₂, CO₂, NO₂, and NO₃ in combination with at least one atom or ion selected from the group of Li, Be, K, Ca, Ti, V, Cr, Mn, Fe, Co, Ni, Cu, Zn, As, Se, Kr, Rb, Sr, Nb, Mo, Pd, Sn, Te, Cs, Ce, Pr, Sm, Gd, Dy, Pb, Pt, Kr, 2K⁺, He⁺, Na⁺, Rb⁺, Sr⁺, Fe³⁺, Mo²⁺, Mo⁴⁺, In³⁺, He⁺, Ar⁺, Xe⁺, Ar²⁺ and H⁺, and Ne⁺ and H⁺.

102. The reactor of claim 1 wherein the catalyst comprises a neon excimer, Ne₂*, which absorbs 27.21 eV and is ionized to 2Ne⁺, to catalyze the transition of atomic hydrogen from the (p) energy level to the (p+1) energy level given by
$$27.21 eV + {Ne}_{2}^{*} + H [ \frac{{a}_{H}}{p} ] \to 2 {Ne}^{+} + H [ \frac{{a}_{H}}{( p + 1 )} ] + [ {( p + 1 )}^{2} - {p}^{2} ] X 13.6 eV 2 {Ne}^{+} \to {Ne}_{2}^{*} + 27.21 eV$$
And, the overall reaction is
$$H [ \frac{{a}_{H}}{p} ] \to H [ \frac{{a}_{H}}{( p + 1 )} ] + [ {( p + 1 )}^{2} - {p}^{2} ] X 13.6 eV .$$

103. The reactor of claim 1 wherein the catalyst comprises helium excimer, He₂*, which absorbs 27.21 eV and is ionized to 2He⁺, to catalyze the transition of atomic hydrogen from the (p) energy level to the (p+1) energy level given by
$$27.21 eV + {He}_{2}^{*} + H [ \frac{{a}_{H}}{p} ] \to 2 {He}^{+} + H [ \frac{{a}_{H}}{( p + 1 )} ] + [ {( p + 1 )}^{2} - {p}^{2} ] X 13.6 eV 2 {H e}^{+} \to {He}_{2}^{*} + 27.21 eV$$
And, the overall reaction is
$$H [ \frac{{a}_{H}}{p} ] \to H [ \frac{{a}_{H}}{( p + 1 )} ] + [ {( p + 1 )}^{2} - {p}^{2} ] X 13.6 eV$$

104. The reactor of claim 1 wherein the catalyst comprises two hydrogen atoms which absorbs 27.21 eV and is ionized to 2H⁺, to catalyze the transition of atomic hydrogen from the (p) energy level to the (p+1) energy level given by
$$27.21 eV + 2 H [ \frac{{a}_{H}}{1} ] + H [ \frac{{a}_{H}}{p} ] \to 2 {H}^{+} + 2 {ⅇ}^{-} + H [ \frac{{a}_{H}}{( p + 1 )} ] + [ {( p + 1 )}^{2} - {p}^{2} ] X 13.6 eV 2 {H}^{+} + 2 {ⅇ}^{-} \to 2 H [ \frac{{a}_{H}}{1} ] + 27.21 eV$$
And, the overall reaction is
$$H [ \frac{{a}_{H}}{p} ] \to H [ \frac{{a}_{H}}{( p + 1 )} ] + [ {( p + 1 )}^{2} - p ] X 13.6 eV .$$

105. The reactor of claim 1 wherein a catalytic disproportionation reaction of atomic hydrogen wherein lower-energy hydrogen atoms, hydrinos, can act as catalysts because each of the metastable excitation, resonance excitation, and ionization energy of a hydrino atom is m×27.2 eV.

106. The reactor of claim 105, wherein the catalytic reaction of a first hydrino atom to a lower energy state affected by a second hydrino atom involves the resonant coupling between the atoms of m degenerate multipoles each having 27.21 eV of potential energy.

107. The reactor of claim 105, wherein the energy transfer of m×27.2 eV from the first hydrino atom to the second hydrino atom causes the central field of the first atom to increase by m and its electron to drop m levels lower from a radius of αₙ/p to a radius of
$$\frac{{a}_{H}}{p + m} .$$

108. The reactor of claim 105 wherein the second interacting lower-energy hydrogen is either excited to a metastable state, excited to a resonance state, or ionized by the resonant energy transfer.

109. The reactor of claim 105 wherein the resonant transfer may occur in multiple stages.

110. The reactor of claim 109 wherein a nonradiative transfer by multipole coupling may occur wherein the central field of the first increases by m, then the electron of the first drops m levels lower from a radius of αₙ/p to a radius of
$$\frac{{a}_{H}}{p + m}$$
with further resonant energy transfer.

111. The reactor of claim 105 wherein the energy transferred by multipole coupling may occur by a mechanism that is analogous to photon absorption involving an excitation to a virtual level.

112. The reactor of claim 105 wherein the energy transferred by multipole coupling during the electron transition of the first hydrino atom may occur by a mechanism that is analogous to two photon absorption involving a first excitation to a virtual level and a second excitation to a resonant or continuum level.

113. The reactor of claim 1, wherein a catalytic reaction with hydrino catalysts for the transition of
$$H [ \frac{{a}_{H}}{p} ]$$
to
$$H [ \frac{{a}_{H}}{p + m} ]$$
induced by a multipole resonance transfer of m·27.21 eV and a transfer of [(p′)²−(p′−m′)]×13.6 eV−m·27.2 eV with a resonance state of
$$H [ \frac{{a}_{H}}{{p}^{′} - {m}^{′}} ]$$
excited in
$$H [ \frac{{a}_{H}}{{p}^{′}} ]$$
is represented by
$$H ⌊ \frac{{a}_{H}}{{p}^{′}} ⌋ + H ⌊ \frac{{a}_{H}}{p} ⌋ -> H [ \frac{{a}_{H}}{{p}^{′} - {m}^{′}} ] + H [ \frac{{a}_{H}}{p + m} ] + [ ( {( p + m )}^{2} - {p}^{2} ) - ( {p}^{′2} - {( {p}^{′} - {m}^{′} )}^{2} ) ] X 13.6 eV$$
Up-m+Hpa+m]+[((+m)₂-p²) 12-m)₂)×13.6 eV
where p, p′, m, and m′ are integers.

114. The reactor of claim 1 wherein the catalytic reaction with hydrino catalysts wherein a hydrino atom with the initial lower-energy state quantum number p and radius
$$\frac{{a}_{H}}{( p + m )}$$
may undergo a transition to the state with lower-energy state quantum number (p+m) and radius α_{H}/m′, by reaction with a hydrino atom with the initial lower-energy state quantum number m′, initial radius α_{H}/m′, and final radius α_{H} that provides a net enthalpy of m·27.2±0.5 eV where m is an integer or m/2·27.2±0.5 eV where m is an integer greater than one.

115. The reactor of claim 114 wherein the catalyst reaction of hydrogen-type atom,
$$H [ \frac{{a}_{H}}{p} ] ,$$
with the hydrogen-type atom,
$$H [ \frac{{a}_{H}}{{m}^{′}} ] ,$$
that is ionized by the resonant energy transfer to cause a transition reaction is represented by
$$mX 27.21 eV + H [ \frac{{a}_{H}}{{m}^{′}} ] + H ⌊ \frac{{a}_{H}}{p} ⌋ -> {H}^{+} + {e}^{-} + H [ \frac{{a}_{H}}{( p + m )} ] + [ {( p + m )}^{2} - {p}^{2} - ( {m}^{′2} - 2 m ) ] X 13.6 eV$$
$${H}^{+} + {e}^{-} -> H [ \frac{{a}_{H}}{1} ] + 13.6 eV$$
And, the overall reaction is
$$H [ \frac{{a}_{H}}{{m}^{′}} ] + H ⌊ \frac{{a}_{H}}{p} ⌋ -> H [ \frac{{a}_{H}}{1} ] + H [ \frac{{a}_{H}}{( p + m )} ] + [ 2 pm + {m}^{2} - {m}^{′2} ] X 13.6 eV + 13.6 eV$$

116. The reactor of claim 1 wherein the catalyst comprises a mixture of a first catalyst and a source of a second catalyst.

117. The reactor of claim 116 wherein the first catalyst produces the second catalyst from the source of the second catalyst.

118. The reactor of claim 117 wherein the energy released by the catalysis of hydrogen by the first catalyst produces a plasma in the energy cell.

119. The reactor of claim 117 wherein the energy released by the catalysis of hydrogen by the first catalyst ionizes the source of the second catalyst to produce the second catalyst.

120. The reactor of claim 116 wherein the first catalyst provides a net enthalpy of m·27.2±0.5 eV where m is an integer or m/2·27.2±0.5 eV where m is an integer greater than one corresponding to a resonant state energy level of the catalyst that is excited to provide the enthalpy.

121. The reactor of claim 116, wherein the second catalyst is selected from the group of helium, neon, or argon and the second catalyst is selected from the group of He⁺, Ne⁺, and Ar⁺ wherein the catalyst ion is generated from the corresponding atom by a plasma created by catalysis of hydrogen by the first catalyst.

122. The reactor of claim 1 wherein the cell comprises at least one of the group of a microwave cell, plasma torch cell, radio frequency (RF) cell, glow discharge cell, barrier electrode cell, plasma electrolysis cell, a pressurized gas cell, filament cell or rt-plasma cell, and a combination of a glow discharge cell and a microwave cell and or RF plasma cell.

123. The reactor of claim 1 comprising a vessel having a chamber capable of containing a vacuum or pressures greater than atmospheric, a source of atomic hydrogen comprising a means to dissociate molecular hydrogen to atomic hydrogen, and a means to heat the source of catalyst capable of providing a net enthalpy of m·27.2±0.5 eV where m is an integer or m/2·27.2±0.5 eV where m is an integer greater than one.

124. The reactor of claim 1 wherein the source of atomic hydrogen comprises a hydrogen dissociator.

125. The reactor of claim 124, wherein the hydrogen dissociator comprises a filament.

126. The reactor of claim 125, wherein the filament comprises a tungsten filament.

127. The reactor of claim 124, further comprising a heater to heat the catalyst to form a gaseous catalyst.

128. The reactor of claim 127 wherein the catalyst comprises at least one of potassium, rubidium, cesium and strontium metal, nitrate, or carbonate.

129. The reactor of claim 1 further comprising a hydrogen supply tube and a hydrogen supply passage to supply hydrogen gas to the vessel.

130. The reactor of claim 1 further comprising a hydrogen flow of hydrogen flow controller and valve to control the flow of hydrogen to the chamber.

131. The reactor of claim 1 comprising a plasma gas, a plasma gas supply, and a plasma gas passage.

132. The reactor of claim 1 comprising lines, valves, and flow regulators such that the plasma gas flows from the plasma gas supply via the plasma gas passage into the vessel.

133. The reactor of claim 1 wherein the plasma gas flow controller and control valve control the flow of plasma gas into the vessel.

134. The reactor of claim 1 further comprising a hydrogen-plasma-gas mixer and mixture flow regulator.

135. The reactor of claim 1 further comprising a hydrogen-plasma-gas mixture, a hydrogen-plasma-gas mixer, and a mixture flow regulator which control the composition of the mixture and the its flow into the vessel.

136. The reactor of claim 1 further comprising a passage for the flow of the hydrogen-plasma-gas mixture into the vessel.

137. The reactor of claim 136, wherein the plasma gas comprises at least one of the group of helium, neon, or argon.

138. The reactor of claim 136, wherein the plasma gas is a source of the catalyst selected from the group of He⁺, Ne⁺, and Ar⁺.

139. The reactor of claim 1 wherein the plasma gas is a source of catalyst and the hydrogen-plasma-gas mixture flows into the plasma and becomes catalyst and atomic hydrogen in the vessel.

140. The reactor of claim 1 further comprising a vacuum pump and vacuum lines.

141. The reactor of claim 140, wherein the vacuum pump evacuates the vessel through the vacuum lines.

142. The reactor of claim 1 further comprising a gas flow means to provide that the reactor is operated under flow conditions with the hydrogen and the catalyst supplied continuously from the catalyst source and the hydrogen source.

143. The reactor of claim 1 further comprising a catalyst reservoir and a catalyst supply passage for the passage of the gaseous catalyst from the reservoir to the vessel.

144. The reactor of claim 1 further comprising a catalyst reservoir heater and a power supply to heat the catalyst in the catalyst reservoir to provide the gaseous catalyst.

145. The reactor of claim 144, wherein the catalyst reservoir heater comprises a temperature control means wherein the vapor pressure of the catalyst is controlled by controlling the temperature of the catalyst reservoir.

146. The reactor of claim 1 wherein the catalyst is one selected from the group of Li, Be, K, Ca, Ti, V, Cr, Mn, Fe, Co, Ni, Cu, Zn, As, Se, Kr, Rb, Sr, Nb, Mo, Pd, Sn, Te, Cs, Ce, Pr, Sm, Gd, Dy, Pb, Pt, He⁺, Na⁺, Rb⁺, Sr⁺, Fe³⁺, Mo²⁺, Mo⁴⁺, K⁺/K⁺, and In³⁺.

147. The reactor of claim 1 further comprising a chemically resistant open container such as a ceramic boat located inside the vessel which contains the catalyst.

148. The reactor of claim 1 further comprising a heater to maintain an elevated cell temperature such that the catalyst in the boat is sublimed, boiled, or volatilized into the gas phase.

149. The reactor of claim 148 wherein the catalyst boat further comprises a boat heater, and a power supply that heats the catalyst in the catalyst boat to provide the gaseous catalyst to the vessel.

150. The reactor of claim 149, wherein the catalyst boat heater comprises a temperature control means wherein the vapor pressure of the catalyst is controlled by controlling the temperature of the catalyst boat.

151. The reactor of claim 1 further comprising a lower-energy hydrogen species and lower-energy hydrogen compound trap.

152. The reactor of claim 1 further comprising a vacuum pump in communication with the trap to cause a pressure gradient from the vessel to the trap to cause gas flow and transport of the lower-energy hydrogen species or lower-energy hydrogen compound.

153. The reactor of claim 1 further comprising a passage from the vessel to the trap and a vacuum line from the trap to the pump, and further comprising valves to and from the trap.

154. The reactor of claim 1 wherein the vessel comprises a stainless steel alloy cell, a molybdenum cell, a tungsten cell, a glass, quartz, or ceramic cell.

155. The reactor of claim 1 further comprising at least one of the group of an aspirator, atomizer, or nebulizer to form an aerosol of the source of catalyst.

156. The reactor of claim 1 wherein the aspirator, atomizer, or nebulizer injects the source of catalyst or catalyst directly into the plasma.

157. The reactor of claim 1 further comprising a plasma gas and a catalyst that is agitated from a source and supplied to the vessel through a flowing gas stream.

158. The reactor of claim 157, wherein the flowing gas stream comprises hydrogen gas or plasma gas which may be an additional source of catalyst.

159. The reactor of claim 158 wherein the additional source of catalyst comprises helium, neon, or argon.

160. The reactor of claim 1 wherein the catalyst is dissolved or suspended in a liquid medium such as water and solution or suspension is aerosolized.

161. The reactor of claim 160 wherein the medium is contained in the catalyst reservoir.

162. The reactor of claim 160 wherein the solution or suspension containing catalyst is transported to the vessel by a carrier gas.

163. The reactor of claim 162 wherein the carrier gas comprises at least one of the group of hydrogen, helium, neon, or argon.

164. The reactor of claim 162, wherein the carrier gas comprises at least one of the group of helium, neon, or argon which serves as a source of catalyst and is ionized by the plasma to form at least one of the catalysts He⁺, Ne⁺, and Ar⁺.

165. The reactor of claim 1 wherein the nonthermal plasma temperature is maintained in the range of 5,000-5,000,000° C.

166. The reactor of claim 1 wherein the cell temperature is maintained above that of the catalyst reservoir which serves as a controllable source of catalyst.

167. The reactor of claim 1 wherein the cell temperature is maintained above that of the catalyst boat which serves as a controllable source of catalyst.

168. The reactor of claim 1 wherein a stainless steel alloy cell is preferably maintained in the temperature range of 0-1200° C.

169. The reactor of claim 1 wherein a molybdenum cell is preferably maintained in the temperature range of 0-1800° C.

170. The reactor of claim 1 wherein a tungsten cell is preferably maintained in the temperature range of 0-3000° C.

171. The reactor of claim 1 wherein a glass, quartz, or ceramic cell is preferably maintained in the temperature range of 0-1800° C.

172. The reactor of claim 1 wherein molecular and atomic hydrogen partial pressures in the vessel is maintained in the range of 1 mtorr to 100 atm.

173. The reactor of claim 1 wherein molecular and atomic hydrogen partial pressures in the vessel is maintained in the range of 100 mtorr to 20 torr.

174. The reactor of claim 1 wherein catalyst partial pressure in the vessel is maintained in the range of 1 mtorr to 100 atm.

175. The reactor of claim 1 wherein the catalyst partial pressure in the vessel is maintained in the range of 100 mtorr to 20 torr.

176. The reactor of claim 1 wherein the flow rate of the plasma gas is 0.00000001 to 1 standard liters per minute per cm³ of vessel volume.

177. The reactor of claim 1 wherein the flow rate of the plasma gas is 0.001 to 10 sccm per cm³ of vessel volume.

178. The reactor of claim 1 wherein the flow rate of the hydrogen gas is 0.00000001 to 1 standard liters per minute per cm³ of vessel volume.

179. The reactor of claim 1 wherein the flow rate of the hydrogen gas is 0.001-10 sccm per cm³ of vessel volume.

180. The reactor of claim 1, wherein a plasma gas comprises one selected from helium, neon, and argon comprising a composition of the plasma gas in the range of 99 to 1%.

181. The reactor of claim 1, wherein a hydrogen-plasma-gas mixture comprises one selected from helium, neon, and argon comprising a composition of the plasma gas in the range of 99 to 95%.

182. The reactor of claim 179 wherein the flow rate of the hydrogen-plasma-gas mixture is 0.00000001 to 1 standard liters per minute per cm³ of vessel volume.

183. The reactor of claim 179 wherein the flow rate of the hydrogen-plasma-gas mixture is 0.001-10 sccm per cm³ of vessel volume.

184. The reactor of claim 1 further comprising a selective valve for removal of lower-energy hydrogen products.

185. The reactor of claim 1 wherein the selectively removed lower-energy hydrogen products comprises dihydrino molecules.

186. The reactor of claim 1 further comprising a cold wall or cryotrap to which at least one of increased binding energy hydrogen compounds and dihydrino gas are cryopumped.

187. The reactor of claim 1 comprises at least on of the group of an rt-plasma cell and a plasma electrolysis reactor, a barrier electrode reactor, an RF plasma reactor, a pressurized gas energy reactor, a gas discharge energy reactor, a microwave cell energy reactor, and a combination of a glow discharge cell and a microwave and or RF plasma reactor wherein the power supplied to the cell is pulsed or intermittent.

188. The reactor of claim 187 wherein the frequency of alternating power may be within the range of at least one of about 0.001 Hz to 100 GHz, about 60 Hz to 10 GHz, and about 10 MHz to 10 GHz.

189. The reactor of claim 187 further comprising two electrodes wherein one or more electrodes are at least one of in direct contact with the plasma and the electrodes may be separated from the plasma by a dielectric barrier wherein the peak voltage may be within the range of at least one of about 1 V to 10 MV, about 10 V to 100 kV, and about 100 V to 500 V.

190. The reactor of claim 189 further comprising at least one antenna to deliver power to the plasma.

191. The reactor of claim 1 wherein the cell comprises a glow discharge cell comprising a vessel having a chamber capable of containing a vacuum or pressures greater than atmospheric, a source of atomic hydrogen, a cathode, an anode, a discharge power source to produce a glow discharge plasma, a source of atomic hydrogen, a source of catalyst, and a vacuum pump.

192. The reactor of claim 191 wherein the discharge current is intermittent or pulsed.

193. The reactor of claim 192 wherein an offset voltage is between 0.5 and 500 V or the offset voltage is set to provide a field between 1 V/cm to 10 V/cm.

194. The reactor of claim 192 wherein the pulse frequency is between 0.1 Hz and 100 MHz and a duty cycle is between 0.1% and 95%.

195. The reactor of claim 191 comprising a hollow cathode comprising a compound electrode comprising multiple electrodes in series or parallel that may occupy a substantial portion of the volume of the reactor.

196. The reactor of claim 195 comprising multiple hollow cathodes in parallel so that a desired electric field is produced in a large volume to generate a substantial power level.

197. The reactor of claim 196 comprising an anode and at least one of the group of multiple concentric hollow cathodes each electrically isolated from the common anode and multiple parallel plate electrodes connected in series.

198. The reactor of claim 191 wherein the discharge voltage is at least one of within the range of about 1000 to about 50,000 volts; the current is at least one of within the range of about 1 μA to about 1 A and about 1 mA.

199. The reactor of claim 191 wherein the power is applied as an alternating current (AC).

200. The reactor of claim 199 wherein the frequency is at least within the range of about 0.001 Hz to 1 GHz, about 60 Hz to 100 MHz, and about 10 to 100 MHz.

201. The reactor of claim 199 comprising two electrodes wherein one or more electrodes are in direct contact with the plasma.

202. The reactor of claim 201 wherein the peak voltage is at least within the range of about 1 V to 10 MV, about 10 V to 100 kV, and about 100 V to 500 V.

203. The reactor of claim 191 comprising an intermittent or pulsed current wherein the offset voltage is at least one of within the range of about 0.5 to about 500 V, is set to provide a field of about 0.1 V/cm to about 50 V/cm, and is set to provide a field between about 1 V/cm to about 10 V/cm; the peak voltage is at least one of within the range of about 1 V to 10 MV, about 10 V to 100 kV, and about 100 V to 500 V; the pulse frequency is within the range of about 1 to about 200 Hz, and the duty cycle is at least one of within the range of about 0.1% to about 95% and about 1% to about 50%.

204. The reactor of claim 1 wherein the cell comprises a microwave plasma forming gas cell comprising a vessel having a chamber capable of containing a vacuum or pressures greater than atmospheric, a source of atomic hydrogen comprising plasma dissociation of molecular hydrogen, a source of microwave power, and a source of catalyst capable of providing a net enthalpy of m·27.2±0.5 eV where m is an integer or m/2·27.2±0.5 eV where m is an integer greater than one.

205. The reactor of claim 204 wherein the source of microwave power is a microwave generator, a tunable microwave cavity, waveguide, and a RF transparent window.

206. The reactor of claim 204 wherein the source of microwave power is a microwave generator, a tunable microwave cavity, waveguide, and an antenna.

207. The reactor of claim 204 wherein the microwaves are tuned by a tunable microwave cavity, carried by waveguide, and are delivered to the vessel though the RF transparent window.

208. The reactor of claim 204 wherein the microwaves are tuned by a tunable microwave cavity, carried by waveguide, and are delivered to the vessel though the antenna.

209. The reactor of claim 208, wherein the waveguide is either inside or outside of the cell.

210. The reactor of claim 208, wherein the antenna is either inside or outside of the cell.

211. The reactor of claim 204, wherein the microwave generator comprises at least one of the group of traveling wave tubes, klystrons, magnetrons, cyclotron resonance masers, gyrotrons, and free electron lasers.

212. The reactor of claim 205, wherein the microwave window comprises an Alumina or quartz window.

213. The reactor of claim 204 wherein the vessel is a microwave resonator cavity.

214. The reactor of claim 204 wherein the cavity is at least one of the group of Evenson, Beenakker, McCarrol, and cylindrical cavity.

215. The reactor of claim 204 comprising a vessel comprising a cavity that is a reentrant microwave cavity and the source of microwave power that excites a plasma in the reentrant cavity.

216. The reactor of claim 215, wherein the reentrant cavity is an Evenson microwave cavity.

217. The reactor of claim 204 wherein the microwave frequency of the source of microwave power is selected to efficiently form atomic hydrogen from molecular hydrogen.

218. The reactor of claim 204 wherein the microwave frequency of the source of microwave power is selected to efficiently form ions that serve as catalysts from a source of catalyst.

219. The reactor of claim 218, wherein the source of catalyst and catalyst comprises helium, neon, and argon and He⁺, Ne⁺, and Ar⁺, respectively.

220. The reactor of claim 204 wherein the microwave frequency of the source of microwave power is in the range of 1 MHz to 100 GHz.

221. The reactor of claim 204 wherein the microwave frequency of the source of microwave power is in the range of 50 MHz to 10 GHz.

222. The reactor of claim 204 wherein the microwave frequency of the source of microwave power is in the range of 75 MHz±50 MHz.

223. The reactor of claim 204 wherein the microwave frequency of the source of microwave power is in the range of 2.4 GHz±1 GHz.

224. The reactor of claim 204 wherein the catalyst is atomic hydrogen wherein the hydrogen pressure of the hydrogen microwave plasma is within at least one of the range of about 1 mtorr to about 100 atm, about 100 mtorr to about 1 atm, and about 100 mtorr to about 10 torr; the microwave power density is within at least one of the range of about 0.01 W to about 100 W/cm³ vessel volume, and the hydrogen flow rate is within at least one of the range of about 0-1 standard liters per minute per cm³ of vessel volume and about 0.001-10 sccm per cm³ of vessel volume.

225. The reactor of claim 204 wherein the power density of the source of plasma power is 0.01 W to 100 W/cm³ vessel volume.

226. The reactor of claim 204 wherein the cell is a microwave resonator cavity.

227. The reactor of claim 204 wherein the source of microwave supplies sufficient microwave power density to the cell to ionize a source of catalyst to form the catalyst.

228. The reactor of claim 227, wherein the source of catalyst comprises as at least one of helium, neon, or argon to form a catalyst such as He⁺, Ne⁺, and Ar⁺, respectively.

229. The reactor of claim 204 wherein the microwave power source forms a nonthermal plasma.

230. The reactor of claim 229 wherein the microwave power source or applicator is an antenna, waveguide, or cavity.

231. The reactor of claim 227 wherein the microwave power source forms a nonthermal plasma.

232. The reactor of claim 231 wherein the microwave power source or applicator is an antenna, waveguide, or cavity.

233. The reactor of claim 232 wherein the species corresponding to the source of catalyst have a higher temperature than that at thermal equilibrium.

234. The reactor of claim 233 wherein the source of catalyst comprises at least one selected from the group of helium, neon, and argon atoms.

235. The reactor of claim 234 wherein higher energy states such as ionized states of the source of catalyst are predominant over that of hydrogen compared to a corresponding thermal plasma wherein excited states of hydrogen are predominant.

236. The reactor of claim 204 comprising a plurality of sources of microwave power.

237. The reactor of claim 236 wherein the plurality of microwave sources are used simultaneously.

238. The reactor of claim 247 wherein the plurality of microwave sources comprise Evenson cavities.

239. The reactor of claim 204 wherein the reactor forms a nonthermal plasma maintained by multiple Evenson cavities operated in parallel.

240. The reactor of claim 239 that is cylindrical and comprises a quartz cell with Evenson cavities spaced along the longitudinal axis.

241. The reactor of claim 204 wherein the frequency of the alternating power is at least one of within the range of about 100 MHz to 100 GHz, about 100 MHz to 10 GHz, and about 1 GHz to 10 GHz or about 2.4 GHz±1 GHz, the pulse frequency is at least one of within the range of about 0.1 Hz to about 100 MHz, about 10 to about 10,000 Hz, and about 100 to about 1000 Hz; the duty cycle is at least one of within the range of about 0.001% to about 95% and about 10%; the peak power density of the pulses into the plasma is at least one of within the range of about 1 W/cm³ to 1 GW/cm³, about 10 W/cm³ to 10 MW/cm³, and about 100 W/cm³ to 10 kW/cm³, and the average power density into the plasma is at least one of within the range of about 0.001 W/cm³ to 1 kW/cm³, about 0.1 W/cm³ to 100 W/cm³, and about 1 W/cm³ to 10 W/cm³.

242. The reactor of claim 241 wherein the source microwaves comprise at least one from the group of traveling wave tubes, klystrons, magnetrons, cyclotron resonance masers, gyrotrons, and free electron lasers.

243. The reactor of claim 241 wherein the power is amplified with an amplifier.

244. The reactor of claim 241 wherein the pulsed microwaves power source comprises at least one of a magnetron with a pulsed high voltage to the magnetron and a pulsed magnetron current that may be supplied by a pulse of electrons from an electron source such as an electron gun.

245. The reactor of claim 1 comprising an RF plasma forming gas cell comprising a vessel, a source of atomic hydrogen from RF plasma dissociation of molecular hydrogen, a source of RF power, and a catalyst capable of providing a net enthalpy of m·27.2±0.5 eV where m is an integer or m/2·27.2±0.5 eV where m is an integer greater than one.

246. The reactor of claim 245 wherein the RF power is capacitively or inductively coupled to the cell.

247. The reactor of claim 245 further comprising two electrodes.

248. The reactor of claim 245 comprising a coaxial cable connected to the a powered electrode by a coaxial center conductor.

249. The reactor of claim 245 comprising a coaxial center conductor connected to an external source coil which is wrapped around the cell.

250. The reactor of claim 249 wherein the coaxial center conductor connected to an external source coil which is wrapped around the cell terminates without a connection to ground.

251. The reactor of claim 249 wherein the coaxial center conductor connected to an external source coil which is wrapped around the cell is connect to ground.

252. The reactor of claim 251 comprising two electrodes wherein the electrodes are parallel plates.

253. The reactor of claim 252 wherein the one of the parallel plate electrodes is powered and the other is connected to ground.

254. The reactor of claim 247 wherein the cell comprises a Gaseous Electronics Conference (GEC) Reference Cell or modification thereof.

255. The reactor of claim 245 wherein the RF power is at 13.56 MHz.

256. The reactor of claim 249 wherein at least one wall of the cell wrapped with the external coil is at least partially transparent to the RF excitation.

257. The reactor of claim 245 wherein the RF frequency is preferably in the range of about 100 Hz to about 100 GHz.

258. The reactor of claim 245 wherein the RF frequency is preferably in the range of about 1 kHz to about 100 MHz.

259. The reactor of claim 245 wherein the RF frequency is preferably in the range of about 13.56 MHz±50 MHz or about 2.4 GHz±1 GHz.

260. The reactor of claim 1 comprising an inductively coupled toroidal plasma cell comprising a vessel, a source of atomic hydrogen comprising RF plasma dissociation of molecular hydrogen, a source of RF power, and a catalyst capable of providing a net enthalpy of m·27.2±0.5 eV where m is an integer or m/2·27.2±0.5 eV where m is an integer greater than one.

261. The reactor of claim 260 comprising the Astron system of Astex Corporation described in U.S. Pat. No. 6,150,628.

262. The reactor of claim 260 comprising a primary of a transformer circuit.

263. The reactor of claim 260 comprising a primary of a transformer circuit driven by a radio frequency power supply.

264. The reactor of claim 260 comprising a primary of a transformer circuit wherein the plasma is a closed loop which acts at as a secondary of the transformer circuit.

265. The reactor of claim 260 wherein the RF frequency is in the range of about 100 Hz to about 100 GHz.

266. The reactor of claim 260 wherein the RF frequency is in the range of about 1 kHz to about 100 MHz.

267. The reactor of claim 260 wherein the RF frequency is in the range of about 13.56 MHz±50 MHz or about 2.4 GHz±1 GHz.

268. The reactor of claim 245 wherein the frequency of the RF power is at least one of in the range of about 100 Hz to about 100 MHz, about 1 kHz to about 50 MHz, and about 13.56 MHz±50 MHz; the pulse frequency is at least one of about 0.1 Hz to about 100 MHz, about 10 Hz to about 10 MHz, about 100 Hz to about 1 MHz; the duty cycle is at least one of in the range of about 0.001% to about 95% and about 0.1% to about 10%; the peak power density of the pulses into the plasma is at least one of within the range of about 1 W/cm³ to 1 GW/cm³ about 10 W/cm³ to 10 MW/cm³, and about 100 W/cm³ to 10 kW/cm³, and the average power density into the plasma is at least one of within the range of about 0.001 W/cm³ to 1 kW/cm³, about 0.1 W/cm³ to 100 W/cm³, and about 1 W/cm³ to 10 W/cm³.

269. The reactor of claim 1 wherein the cell comprises a plasma forming electrolytic cell comprising a vessel, a cathode, an anode, an electrolyte, a high voltage electrolysis power supply, and a catalyst capable of providing a net enthalpy of m·27.2±0.5 eV where m is an integer or m/2·27.2±0.5 eV where m is an integer greater than one.

270. The reactor of claim 269 wherein the voltage is in the range 10-50 kV and the current density in the range of 1 to 100 A/cm².

271. The reactor of claim 269, wherein the cathode comprises tungsten.

272. The reactor of claim 269 wherein the anode comprises platinum.

273. The reactor of claim 269 wherein the catalyst comprises at least one selected from the group of Li, Be, K, Ca, Ti, V, Cr, Mn, Fe, Co, Ni, Cu, Zn, As, Se, Kr, Rb, Sr, Nb, Mo, Pd, Sn, Te, Cs, Ce, Pr, Sm, Gd, Dy, Pb, Pt, He⁺, Na⁺, Rb⁺, Sr⁺, Fe³⁺, Mo²⁺, Mo³⁺, K⁺/K⁺, and In³⁺.

274. The reactor of claim 269 wherein the catalyst is formed from a source of catalyst.

275. The reactor of claim 274 wherein the source of catalyst comprises at least one selected from the group of Li, Be, K, Ca, Ti, V, Cr, Mn, Fe, Co, Ni, Cu, Zn, As, Se, Kr, Rb, Sr, Nb, Mo, Pd, Sn, Te, Cs, Ce, Pr, Sm, Gd, Dy, Pb, Pt, He⁺, Na⁺, Rb⁺, Sr⁺, Fe³⁺, Mo²⁺, Mo⁴⁺, In³⁺ and K⁺/K⁺.

276. The reactor of claim 275 wherein the plasma electrolysis discharge voltage within the range of about 1000 to about 50,000 volts, the current into the electrolyte is at least one of within the range of about 1 μA/cm³ to about 1 A/cm³ and about 1 mA/cm³, the offset voltage is below that which causes electrolysis such as within the range of about 0.001 to about 1.4 V, the peak voltage at least one of within the range of about 1 V to 10 MV, about 2 V to 100 kV, and about 2 V to 1 kV, the pulse frequency is at least one of within the range of about 0.1 Hz to about 100 MHz and about 1 to about 200 Hz, and the duty cycle is at least one of within the range of about 0.1% to about 95% and about 1% to about 50%.

277. The reactor of claim 1 wherein the cell comprises a radio frequency (RF) barrier electrode discharge cell comprising a vessel, a source of atomic hydrogen from the RF plasma dissociation of molecular hydrogen, a source of RF power, a cathode, an anode, and a catalyst capable of providing a net enthalpy of m·27.2±0.5 eV where m is an integer or m/2·27.2±0.5 eV where m is an integer greater than one.

278. The reactor of claim 277 wherein at least one of the cathode and the anode is shielded by a dielectric barrier.

279. The reactor of claim 278 wherein the dielectric barrier comprising at least one of the group of glass, quartz, Alumina, and ceramic.

280. The reactor of claim 277 wherein the RF power may be capacitively coupled to the cell.

281. The reactor of claim 277 wherein the electrodes are external to the cell.

282. The reactor of claim 277 wherein a dielectric layer separates the electrodes from the cell wall.

283. The reactor of claim 277 wherein the high driving voltage may be AC and may be high frequency.

284. The reactor of claim 277 wherein the RF source of power comprises a driving circuit comprising a high voltage power source which is capable of providing RF and an impedance matching circuit.

285. The reactor of claim 277 wherein the frequency is in the range 100 Hz to 10 GHz.

286. The reactor of claim 277 wherein the frequency is in the range 1 kHz to 1 MHz.

287. The reactor of claim 277 wherein the frequency is in the range 5-10 kHz.

288. The reactor of claim 277 wherein the voltage is in the range 100 V to 1 MV.

289. The reactor of claim 277 wherein the voltage is in the range 1 kV to 100 kV.

290. The reactor of claim 277 wherein the voltage is in the range 5 to 10 kV.

291. The reactor of claim 277 wherein the frequency is at least one of within the range of about 100 Hz to about 10 GHz, about 1 MHz, and about 5-10 kHz, and the voltage is at least one of within the range of about 100 V to about 1 MV, about 1 kV to about 100 kV, and about 5 to about 10 kV.

292. The reactor of claim 1 wherein the plasma gas is at least one of helium, neon, and argon corresponding to a source of the catalysts He⁺, Ne⁺, and Ar⁺, respectively.

293. The reactor of claim 1 wherein hydrogen is flowed into the plasma cell separately or as a mixture with other plasma gases such as those that serve as sources of catalysts.

294. The reactor of claim 293 wherein the flow rate of the catalyst gas or hydrogen-catalyst gas mixture such as at least one gas selected for the group of hydrogen, argon, helium, argon-hydrogen mixture, helium-hydrogen mixture is at least one of within the range of about 0.00000001 to 1 standard liters per minute per cm³ of vessel volume, and about 0.001-10 sccm per cm³ of vessel volume.

295. The reactor of claim 294 wherein the percentage of the source of catalyst gas in a helium, neon, or argon-hydrogen mixture is at least one of within the range of about 99.99 to about 0.01%, about 99 to about 1%, and about 99 to about 95%.

296. A method for producing power and lower-energy-hydrogen species and compounds comprising the steps of:
providing a vessel, a source of atomic hydrogen, a source of pulsed or intermittent power, and a catalyst capable of providing a net enthalpy of m·27.2±0.5 eV where m is an integer or m/2·27.2±0.5 eV where m is an integer greater than one;
forming a plasma in the vessel with the source of power;
forming atomic hydrogen in the plasma;
reacting the catalyst with the atomic hydrogen to form lower-energy-hydrogen species and compounds.

297. The method for producing power and lower-energy-hydrogen species and compounds of claim 296 further comprising the steps of flowing a plasma gas that is a source of catalyst into the vessel.

298. The method for producing power and lower-energy-hydrogen species and compounds of claim 297 further comprising controlling the power by controlling the amount of gaseous catalyst.

299. The method for producing power and lower-energy-hydrogen species and compounds of claim 298 wherein the amount of gaseous catalyst is controlled by controlling the plasma gas flow rate.

300. The method for producing power and lower-energy-hydrogen species and compounds of claim 297 wherein the power is controlled by controlling the amount of hydrogen.

301. The method for producing power and lower-energy-hydrogen species and compounds of claim 300 wherein the power is controlled by controlling the flow of hydrogen from the source of hydrogen.

302. The method for producing power and lower-energy-hydrogen species and compounds of claim 300 wherein the power is controlled by controlling the flow of hydrogen and plasma gas and the ratio of hydrogen to plasma gas in a mixture.

303. The method for producing power and lower-energy-hydrogen species and compounds of claim 297 wherein the source of catalyst is at least one selected from the group of helium, neon, or argon which provides catalysts He⁺, Ne⁺, and Ar⁺ respectively.

304. The method for producing power and lower-energy-hydrogen species and compounds of claim 302 wherein the power is controlled by controlling the hydrogen flow rate, plasma gas flow rate, and hydrogen-plasma-gas flow rate with at least one of the group of a flow regulator, a hydrogen-plasma-gas mixer, flow rate controllers, and valves.

305. The method for producing power and lower-energy-hydrogen species and compounds of claim 296 wherein the power is controlled by controlling the temperature of the plasma with the power supplied by the source of input power.

306. The method for producing power and lower-energy-hydrogen species and compounds of claim 296 further comprising the steps of providing a source of catalyst from a catalyst reservoir.

307. The method for producing power and lower-energy-hydrogen species and compounds of claim 306 wherein the step of providing a source of catalyst from a catalyst reservoir further comprises the steps of controlling the temperature of the catalyst from a catalyst reservoir to control its vapor pressure.

308. The method for producing power and lower-energy-hydrogen species and compounds of claim 296 further comprising the steps of providing a source of catalyst from a catalyst boat.

309. The method for producing power and lower-energy-hydrogen species and compounds of claim 308 further comprising the steps of controlling the temperature of the catalyst from a catalyst boat to control its vapor pressure.

310. The method for producing power and lower-energy-hdyrogen species and compounds of claim 296 wherein an input power is reduced by using an intermittent or pulsed power source.

311. The method for producing power and lower-energy-hdyrogen species and compounds of claim 310 wherein the intermittent or pulsed power source provides a time period wherein the field is set to a desired strength by an offset DC, audio, RF, or microwave voltage or electric and magnetic fields.

312. The method for producing power and lower-energy-hdyrogen species and compounds of claim 311 wherein the field is set to a desired strength during a time period by an offset DC, audio, RF, or microwave voltage or electric and magnetic fields that is below that required to maintain a discharge.

313. The method for producing power and lower-energy-hdyrogen species and compounds of claim 311 wherein the desired field strength during a low-field or nondischarge period optimizes the energy match between the catalyst and the atomic hydrogen.

314. The method for producing power and lower-energy-hdyrogen species and compounds of claim 310 wherein the intermittent or pulsed power source further comprises a means to adjust the pulse frequency and duty cycle to optimize the power balance.

315. The method for producing power and lower-energy-hdyrogen species and compounds of claim 314 wherein the pulse frequency and duty cycle is adjusted to optimize the power balance by optimizing the reaction rate versus the input power.

316. The method for producing power and lower-energy-hdyrogen species and compounds of claim 315 wherein the pulse frequency and duty cycle is adjusted to optimize the power balance by optimizing the reaction rate versus the input power by controlling the amount of catalyst and atomic hydrogen generated by the discharge decay during the low-field or nondischarge period wherein the concentrations are dependent on the pulse frequency, duty cycle, and the rate of plasma decay.
